(19) United States
(12) Patent Application Publication
(10) Pub. No.: US 2006/0080200 A1
(43) Pub. Date: Apr. 13, 2006

(54) System and method for benefit plan administration

(76) Inventors: David M. Ashton, Ankeny, IA (US); Michael J. Beer, West Des Moines, IA (US); Christopher J. Bowman, Urbandale, IA (US); Sheri L. Hasan, Waukee, IA (US); Kent R. Hinders, Des Moines, IA (US); Debra Lynn Kleppe, Urbandale, IA (US); Paul W. Knake, Polk City, IA (US); Beth Ellen Krakau, West Des Moines, IA (US); Bobbi J. Perkins, Adel, IA (US); Jerry L. Ripperger, Urbandale, IA (US); Jeffrey A. Van Baale, Ankeny, IA (US); William J. Kelly, Ankeny, IA (US); Stacie J. Franklin, West Des Moines, IA (US); Susie Thomann, Urbandale, IA (US); Angela M. Ellis, Norwalk, IA (US); Eric W. Hays, West Des Moines, IA (US); Patricia M. Kliegl, Johnston, IA (US)

Correspondence Address: MICHAEL BEST & FRIEDRICH, LLP, 100 E WISCONSIN AVENUE, MILWAUKEE, WI, 53202, US

(21) Appl. No.: 11/186,640

(22) Filed: Jul. 20, 2005

Related U.S. Application Data
(63) Continuation-in-part of application No. 09/824,329, filed on Apr. 2, 2001.
(60) Provisional application No. 60/195,185, filed on Apr. 7, 2000.

(51) Int. Cl. G06Q 40/00

(52) U.S. Cl. 705/35

(57) ABSTRACT

Methods and system of providing benefit plan administration. A method of providing benefit plan administration to a first sponsor having at least one participant enrolled in a benefit plan can include electronically receiving benefit plan information from the first sponsor, electronically providing benefit plan information to the first sponsor, and electronically providing benefit plan information to the at least one participant.

### RELATED APPLICATIONS

The present application is a continuation-in-part of co-pending U.S. patent application Ser. No. 09/824,329 filed on Apr. 2, 2001, which claims priority to U.S. Provisional Patent Application Serial No. 60/195,185 filed on Apr. 7, 2000, the entire contents of which are both herein incorporated by reference.

### FIELD OF THE INVENTION

The invention generally relates to a method and system of administrating benefit plans.

### BACKGROUND OF THE INVENTION

The explosion of employer-sponsored benefit plans carries with it a high administrative burden. This burden falls on both the company underwriting and/or administrating the plan, as well as the plan sponsor, usually an employer.

Information about plan participants (often employees) must be compiled and transferred by the plan sponsor (often an employer) to the plan provider that administers the plan. Thereafter, on an on-going basis, instructions, changes, and money must pass between the plan sponsor and the plan provider in order to operate the plan.

A conventional way of performing these tasks is for the plan sponsor to document the needed information to initialize the plan. This documentation is sent to the plan provider. The plan provider has staff to enter the information into its in-house computer system for processing. Thereafter, sponsors periodically fill out what are called “list bills” (sent from the plan provider), instructing the plan provider as to individual participants' choices regarding the plan (e.g. contribution amounts, investment options, etc.), changing or updating information, or otherwise providing the needed on-going data to effectuate plan participant choices regarding the plan. With the list bill, the plan sponsor typically sends one or more checks correlated to the contributions from participants and/or the plan sponsor.

The plan provider must expend considerable resources to handle and process the information and funds. The list bills and checks must be received and properly handled. Information, retrieved and documented once by the plan sponsor, must now be re-entered (sometimes manually) into the plan provider's computer system.

Many plans allow the purchase of financial securities such as stocks, bonds, etc. By law, the plan provider must buy or sell the securities instructed by the list bill the day they receive the instructions or, make up any difference between the price of the security on the day of the order versus a higher price at any time thereafter. Thus, time is of the essence to process the list bills. A delay in entry, which delays the purchase or selling of securities, puts the plan provider at substantial risk of monetary loss.

Errors in data entry can also be costly. Data entry errors can occur on the list bill. The re-entry of information from the list bill by data entry personnel at the plan provider can also result in errors. These errors must either be rectified or compensated by the plan provider, or may delay the processing of the list bill order, again putting the plan provider at risk as discussed above. Such errors or delays may be individually relatively insignificant, but increase in significance given the number of transactions typically handled by plan providers. The use of list bills requires cumbersome documenting of information and handling of funds by the plan sponsor. The plan provider has to re-handle the list bill information and funds.

Attempts have been made to address these problems. Some methods allow modem dial-in connectivity between the plan sponsor and the plan provider. This is helpful in allowing a plan sponsor to access information about the plan and send data to the plan provider. However, it requires distribution of specialized software to plan sponsor. It is cumbersome and costly to update and maintain the software. Therefore, update and maintenance of the software is usually done only periodically. Such a method also is essentially an electronic data transfer mechanism, but does not allow real time interaction with the plan provider.

Another method allows sponsors subscribing to the plan to access a front end of the plan provider's in-house system and essentially writes data from a plan sponsor to a file. The file can then be given to the in-house computer for retrieval and processing of the information in the file. However, there is no real time interactive ability allowing a plan sponsor to up-date or change data or information relative to the plan.

### SUMMARY OF THE INVENTION

Some embodiments of the invention provide a method of providing benefit plan administration to a first sponsor having at least one participant enrolled in a benefit plan including electronically receiving benefit plan information from the first sponsor, electronically providing benefit plan information to the first sponsor, and electronically providing benefit plan information to the at least one participant.

Another embodiment of the invention provides a system for providing benefit plan administration to a first sponsor having at least one participant enrolled in a benefit plan including a server that receives benefit plan information from the first sponsor, provides secure access to benefit plan information to the first sponsor, and provides secure access to benefit plan information to the at least one participant.

Additional embodiments of the invention include a method of providing benefit plan administration to a sponsor having a plurality of participants enrolled in a benefit plan including receiving benefit plan information from the sponsor, determining eligibility information based on the benefit plan information, and providing the sponsor access to the eligibility information.

Further embodiments of the invention include a method of providing benefit plan administration to a sponsor having at least one participant enrolled in a benefit plan including electronically receiving participant information from the sponsor, wherein electronically receiving participant information from the sponsor includes at least one of manually entering the participant information and importing a file including the participant information.

### BRIEF DESCRIPTION OF THE DRAWINGS

FIG. 1 is a diagram showing the information flow of some embodiments of the invention between a plan participant in a group retirement plan, a plan sponsor of the group retirement plan, and the plan provider of the group retirement plan.

FIG. 2 is an illustration of a home page associated with a web site provided by a group retirement plan provider and accessible to group retirement plan sponsors and plan participants.

FIG. 3 is an illustration of a plan sponsor log-in web page.

FIG. 4 is an illustration of a plan sponsor services selection web page.

FIG. 5 is an illustration showing an information exchange web page accessible to a plan sponsor.

FIG. 6 is an illustration showing a send contribution web page accessible to a plan sponsor that permits a plan sponsor to select the type of contributions to send.

FIG. 7 is an illustration showing a send contributions web page accessible to a plan sponsor.

FIG. 8 is an illustration showing a final approval of contributions to send web page accessible to a plan sponsor.

FIG. 9 is an illustration of a file import of contributions to send web page accessible to a plan sponsor.

FIG. 10 is an illustration of a compliance test selection web page accessible to a plan sponsor.

FIG. 11 is an illustration of a compliance web page accessible to a plan sponsor.

FIG. 12 is an illustration of an electronic funds transfer web page accessible to a plan sponsor.

FIG. 13 is an illustration of an activity ledger web page accessible to a plan sponsor,

FIG. 14 is an illustration of an executive summary options web page accessible to a plan sponsor.

FIG. 15 is an illustration of an executive summary setup web page accessible to a plan sponsor.

FIGS. 16A-16C are diagrams of an investment information web page accessible to a plan sponsor.

FIG. 17 is an illustration of an investment by risk web page accessible to a plan sponsor.

FIG. 18 is an illustration of an investment by age web page accessible to a plan sponsor.

FIG. 19 is an illustration of an investment by salary web page accessible to a plan sponsor.

FIG. 20 is an illustration of participation summary web page accessible to a plan sponsor.

FIG. 21 is an illustration of a participation by age and salary web page accessible to a plan sponsor.

FIG. 22 is an illustration of an interactive telephone usage summary web page accessible to a plan sponsor.

FIG. 23 is an illustration of an interactive telephone usage web page accessible to a plan sponsor.

FIG. 24 is an illustration of a plan participant login web page.

FIG. 25 is an illustration of a retirement services personal summary web page accessible to a plan participant.

FIGS. 26A and 26B are diagrams of a retirement services plan details web page accessible to a plan participant.

FIGS. 27A and 27B are diagrams of a change investment direction web page accessible to a plan participant.

FIG. 28 is an illustration of a transfer existing money web page accessible to a plan participant.

FIG. 29 is an illustration of a rebalance money web page accessible to a plan participant.

FIG. 30 is a block diagram of a system according to one embodiment of the invention.

FIG. 31A is a schematic illustration of a benefit data management system according to one embodiment of the invention.

FIG. 31B is a diagram showing the information flow between a plan participant in a benefit plan, a plan sponsor of the benefit plan, and a plan provider of the benefit plan.

FIG. 32 is an illustration of a login page of the benefit data management system of FIG. 31A according to one embodiment of the invention.

FIGS. 33A and 33B is an illustration of a main menu page of the benefit data management system of FIG. 31A according to one embodiment of the invention

FIGS. 34A and 34B is an illustration of a participant information page of the benefit data management system of FIG. 31A according to one embodiment of the invention.

FIG. 35 is an illustration of a first add participant page of the benefit data management system of FIG. 31A according to one embodiment of the invention.

FIGS. 36A and 36B is an illustration of a second add participant page of the benefit data management system of FIG. 31A according to one embodiment of the invention.

FIG. 37 is an illustration of an add participant address page of the benefit data management system of FIG. 31A according to one embodiment of the invention.

FIG. 38 is an illustration of an add participant summary page of the benefit data management system of FIG. 31A according to one embodiment of the invention.

FIG. 39 is an illustration of an add participant confirmation page of the benefit data management system of FIG. 31A according to one embodiment of the invention.

FIG. 40 is an illustration of an update/view participant page of the benefit data management system of FIG. 31A according to one embodiment of the invention.

FIG. 41 is an illustration of a remove participant page of the benefit data management system of FIG. 31A according to one embodiment of the invention.

FIG. 42 is an illustration of a manage your plan page of the benefit data management system of FIG. 31A according to one embodiment of the invention.

FIG. 43 is an illustration of an eligibility determination report page of the benefit data management system of FIG. 31A according to one embodiment of the invention.

FIG. 44 is an illustration of printable version of an eligibility report of the benefit data management system of FIG. 31A according to one embodiment of the invention.

FIG. 45 is an illustration of another participant information page of the benefit data management system of FIG. 31A according to one embodiment of the invention.

FIG. 46 is an illustration of an electronic summary of benefit plan information generated by the benefit data management system of FIG. 31A according to one embodiment of the invention.

FIGS. 47A and 47B is an illustration of a paper form summary of benefit plan information generated by the benefit data management system of FIG. 31A according to one embodiment of the invention.

FIG. 48 is an illustration of another summary of benefit plan information generated by the benefit data management system of FIG. 31A according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and software components or modules. As such, it should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible.

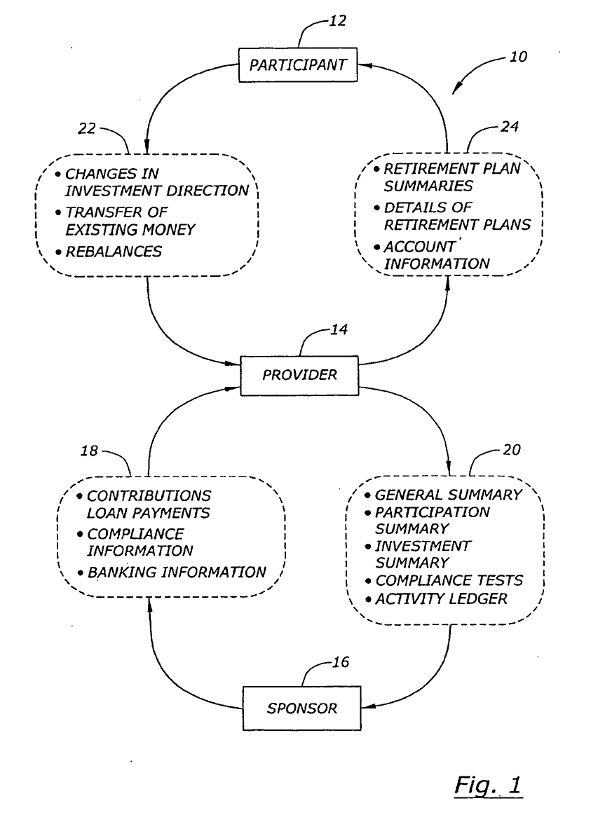

As described with respect to FIGS. 1-30, some embodiments of the invention relate to the information flow and information exchange between the parties in a benefit plan context, such as a retirement planning context. The parties can include one or more participants, one or more sponsors, and a plan provider. Each participant can be an employee of a plan sponsor. The plan sponsor (often an employer) can provide the retirement plan through a plan provider. The plan provider would generally administration services to the plan. Typically, the plan provider would administration services for retirement plans for a number of different participants associated with a number of different sponsors. Retirement planning can include any number of retirement plans, both qualified and non-qualified retirement plans.

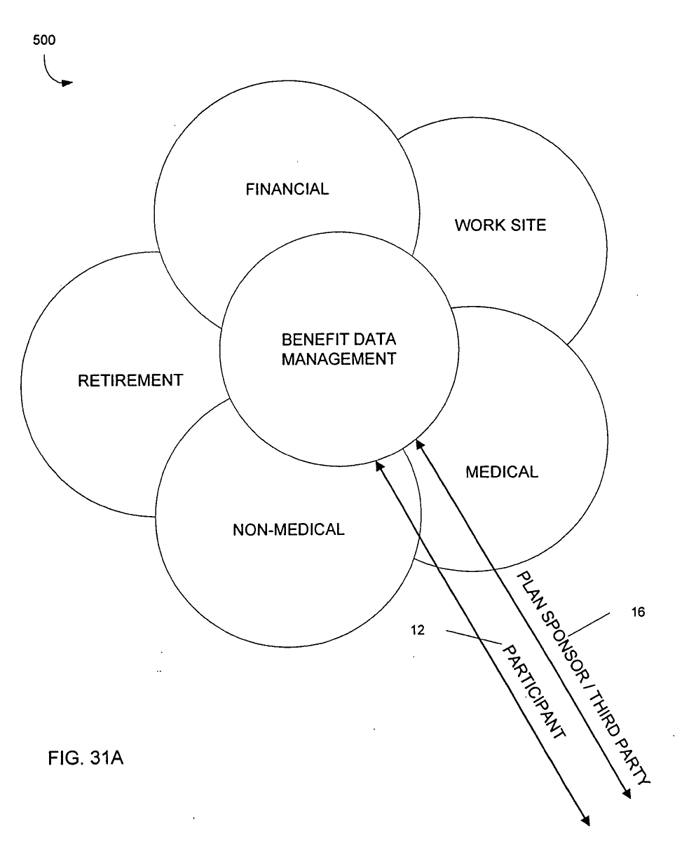

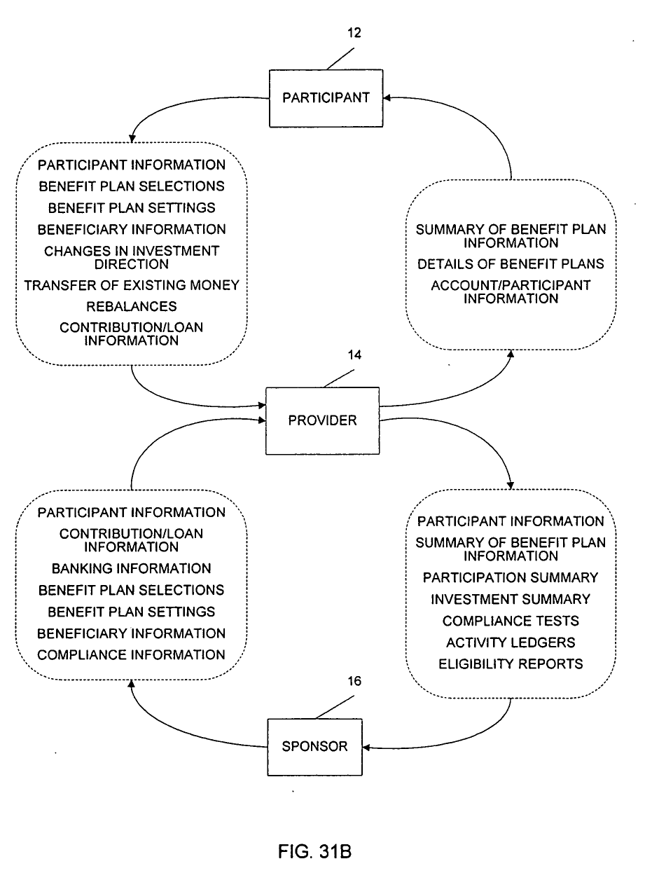

As described with respect to FIGS. 31A-47B, some embodiments of the invention relate to information flow and information exchange between parties in any benefit plan context. Benefit plans can include retirement plans, as well as financial or savings plans, work site plans, medical plans, and non-medical plans.

FIGS. 1-30 and the corresponding description are directed to one embodiment of a method and system for administering 401(k)-type group retirement plans. The invention is not in any way limited to this particular type of group retirement plan or any particular benefit plan.

FIG. 1 illustrates the relationships between the plan participant, the plan provider, and the plan sponsor and the information flow between each entity. In FIG. 1, information flow 10 involves a plan participant 12, a plan provider 14, and a plan sponsor 16. Although only one of each entity is shown, a single provider can provide retirement plan related services to any number of sponsors. Each sponsor can have any number of participants as well. Thus, the plan provider 14 can communicate with a number of sponsors 16 and a number of participants 12. Similarly, each sponsor 16 can have any number of benefit plans, such as several retirement plans.

The plan sponsor 16 can exchange information with the plan provider 14. The plan sponsor 16 can transmit information concerning contributions made to retirement plans of the plan participants associated with the plan sponsor, loan payments made to a retirement account by participants associated with the plan sponsor, compliance information associated with the plan sponsor, and banking information associated with the plan sponsor. Other information associated with the plan sponsor can also be transferred to the plan provider.

The plan provider 14 can transfer information to the sponsor 16. In some embodiments, this information 20 can include general summaries of the retirement plans associated with participants of the plan sponsor, participation summaries, investment summaries, the results of compliance tests, and an activity ledger.

The plan provider 14 can exchange information with the plan participant 12. The plan participant 12 can transfer information 22 to the plan provider 14. In some embodiments, the information 22 can include changes in investment direction, the transfer of existing money, and rebalancing of investment allocation.

In addition, the plan provider 14 can transfer information 24 to the plan participant 12. In some embodiments, this information can include retirement plan summaries, details of retirement plans, and account information.

The information exchange between the plan provider 14 and the sponsor 16 and between the plan provider 14 and participant 12 can occur over the Internet or another network. The information can be presented to and retrieved by the plan provider 14 through use of a World Wide Web based interface. The use of this type of network and this type of interface can provide a convenient method for large numbers of people to access this information. In addition, participants and sponsors would normally have access to the Internet and would not accrue any additional costs when a web-based system is implemented.

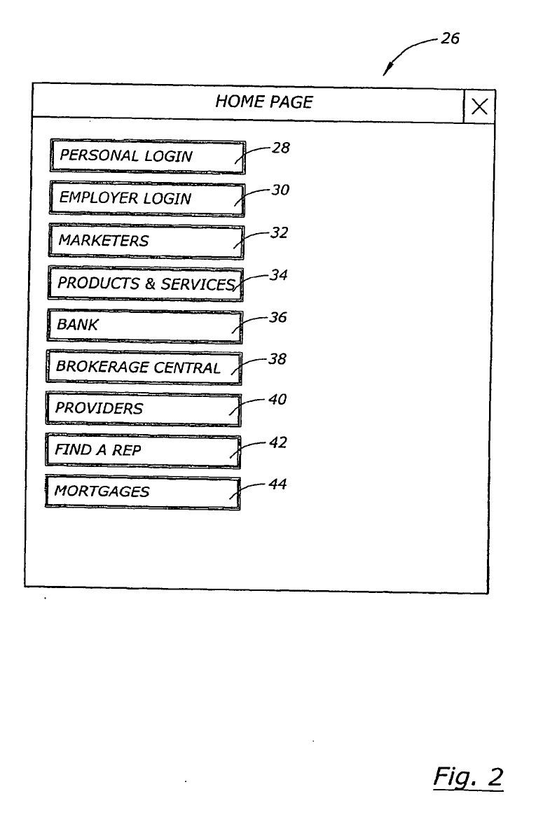

Some embodiments of the invention can be implemented with a web site. FIG. 2 illustrates a home page 26 of a web site implementing one embodiment of the invention. The home page 26 can include a number of links. The links can provide visitors to the home page 26 with access to various types and formats of benefit plan information. The links can include a personal log-in 28 through which a plan participant can personally log into the web site in order to exchange information. Similarly, the employer log-in link 30 can provide sponsors with the ability to access that portion of the web site that permits the plan sponsor to exchange information with the plan provider. Some embodiments of the invention include numerous other links to related services and other information, such as a link to marketers 32, a link to products and services 34, a link to a bank 36, a link to a brokerage center 38, a link to providers 40, a link associated with finding a representative 42, and a link associated with mortgages 44. These additional links can allow participants and sponsors the opportunity to interact with the benefit plan provider for other business purposes.

The web site of some embodiments of the invention is secured. Security can be added through a number of different methods. For example, security can be added through implementation of the secure sockets layer (SSL) protocol or other protocols that implement public/private keys, digital certificates, and other security measures aimed at providing authentication. Similarly, other security protocols or measures can be used. In some embodiments, the plan sponsors and participants must log in to the system by entering an identifier, and a personal identification number (PIN), or other means of identification. The invention is not in anyway limited to the type of security used. However, some embodiments of the invention require that the information exchanged be considered confidential and private by both sponsors and participants.

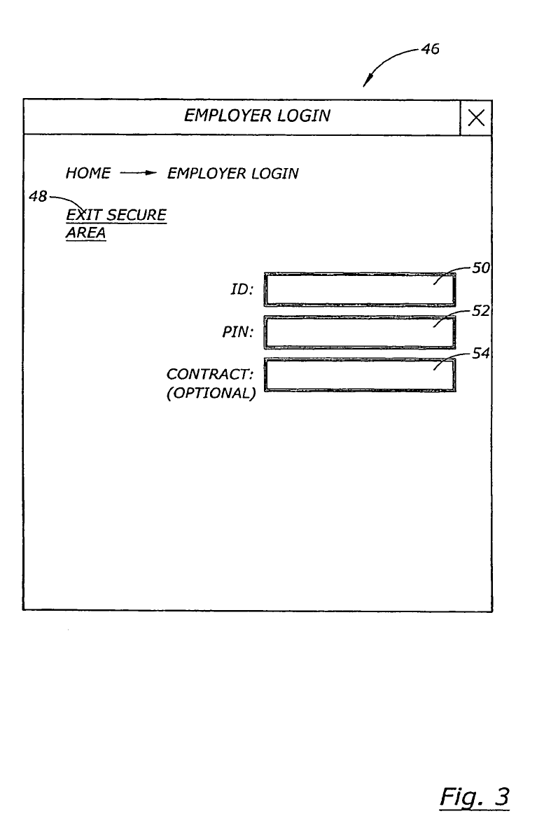

FIG. 3 illustrates a display for a plan sponsor log-in 46. A visitor can access the plan sponsor log-in page 46 and then must either log-in or exit the secure area through link 48. In order to log-in, a plan sponsor must enter the ID 50, a PIN 52, and optionally a contract number 54. Other types and forms of security can be used or such as a particular environment or technology requires.

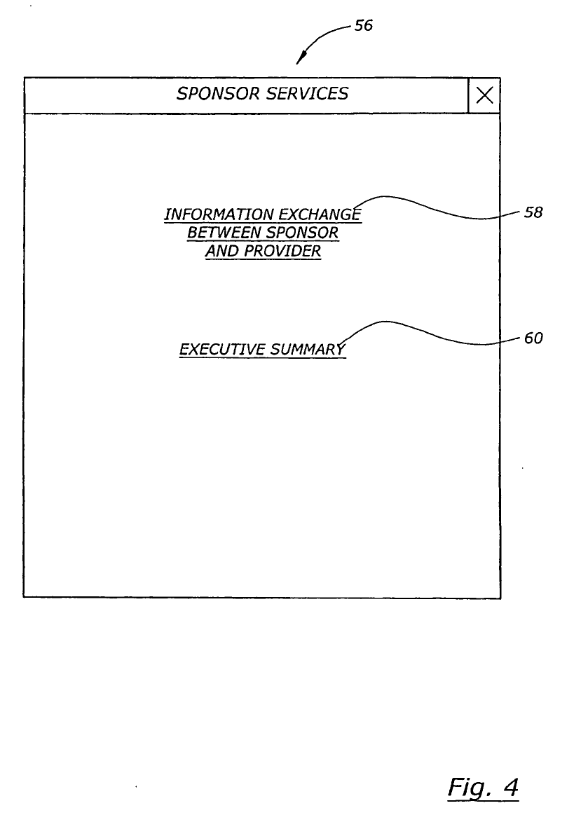

As shown in FIG. 4, once a plan sponsor successfully logs in to the system, the plan sponsor can be given options, such as those presented on the plan sponsor services web page 56. For example, the plan sponsor can choose to follow a link associated with an information exchange between the plan sponsor and the plan provider 58 or the plan sponsor can elect to view a link associated with the executive summary 60.

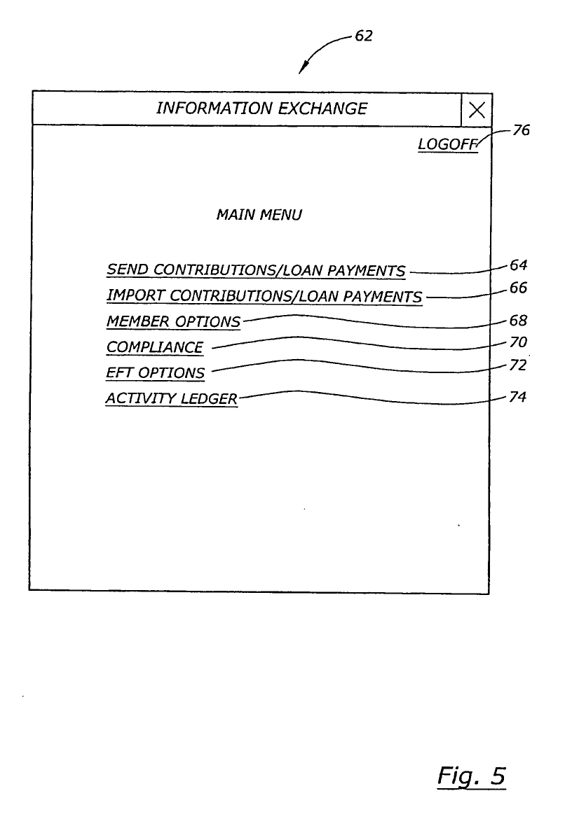

As shown in FIG. 5, once the plan sponsor elects to follow the information exchange link 58, the plan sponsor can be presented with an information exchange main menu web page 62. This web page can provide the plan sponsor with a number of different options related to information that can be exchanged between the plan sponsor and the plan provider. In one embodiment, these options can include following a send contributions/loan payments link 64, following an import contributions/loan payments link 66, following a member options link 68, following a compliance link 70, following an electronic funds transfer (EFT) link 72, and following an activity ledger link 74.

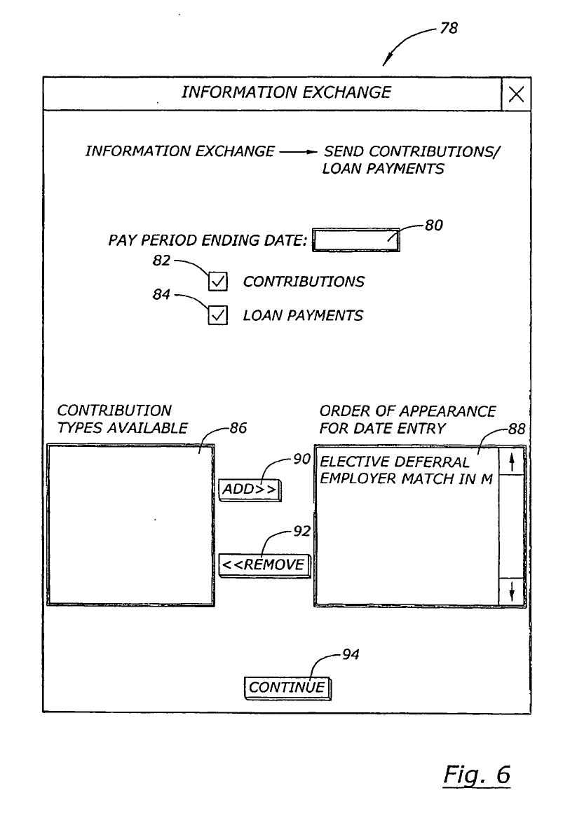

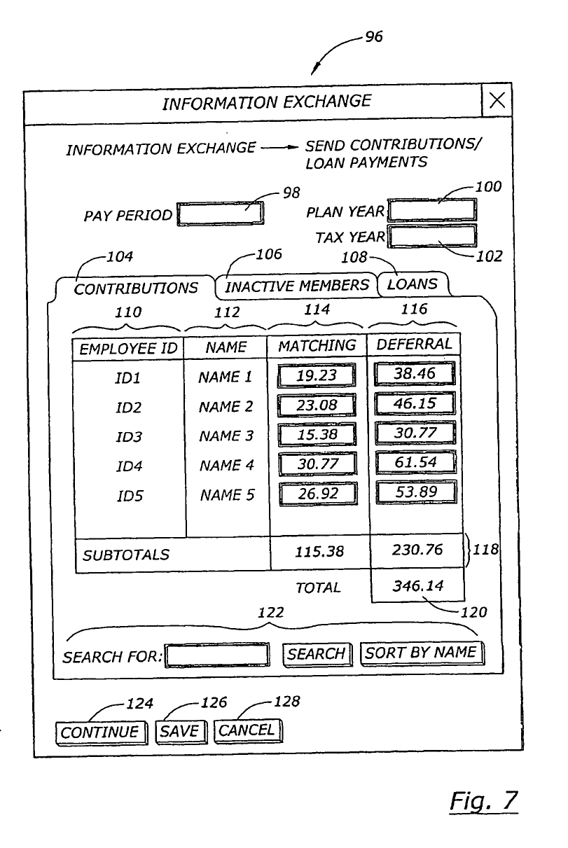

When the plan sponsor chooses to navigate to the send contributions/loan payments option, the plan sponsor can be presented with a send contributions/loan payment, as shown in web page of FIG. 6. The send contributions/loan payments page 78 can be the first web page in a series of web pages that permit the plan sponsor to electronically send contributions and loan payments to the plan provider. The plan sponsor can specify a pay period ending date 80, and whether the information to be exchanged includes contributions 82 and/or loan payments 84. The plan sponsor can also set the types of contributions that will be sent. Different types of contributions can be selected from a first list box 86. The add button 90 can be used to move these types of contributions to the list box 88 containing the types of contributions/loan payments to send. One or more contribution types can be removed from the list box 88 by selecting a contribution type and then using the remove button 92. In one embodiment, the contribution types can include an elective deferral, which is a contribution made by a plan participant and then deducted by a plan sponsor from the plan participant's wages or otherwise electively deferred. Another example of a contribution type is an employer matching contribution in which an employer contributes an amount to the retirement plan of a plan participant. Once the contribution types have been determined, the plan sponsor can use the continue button 94 to proceed to the web page shown in FIG. 7.

FIG. 7 illustrates another web page 96 associated with the plan sponsor sending contributions/loan payments to the plan provider. In one embodiment, the information provided includes a pay period 98, a plan year 100, and a tax year 102. Web page 96 can also include a tab control or another implementation of a tab-like display. A user can access the information associated with each tab. In one embodiment, the tabs can include information such as contributions 104, inactive members 106, loans 108, negative contributions (not shown), and forfeitures (not shown).

The contributions tab 104 can include an ID column 110 for displaying employee identification numbers, which can be social security numbers in some embodiments. A name column 112 can display the names of employees who may be making contributions. A matching column 114 and a loans column 116 can be used to display the matching contributions for an employee made by a plan sponsor and the contribution made (amount deferred) by the employee or participant. The plan sponsor can modify these amounts accordingly by inputting or changing values entered in the text boxes in the matching column and the deferred column. For example, the employer or sponsor can choose to contribute one half of the amount that the employee or participant elects to defer. A subtotal 18 for each type of contribution can be displayed and a total 120 for the combined amount of the contributions can also be displayed.

Additional functionality can be provided through search and sort functions 122 that can allow a user to search for a particular employee or to sort employees. The search and sort functions can be used where there are a large number of employees or participants associated with a single sponsor. Navigation buttons can also be used on web page 96. For example, a continue button 124 may be used to proceed to the next screen in a sequence of screens. A save button 126 can allow the current information to be saved, and a cancel button 128 can ensure that changes made are not saved.

Although the contents of other tabs are not shown, each tab can include other information that a plan sponsor can use in sending contributions, loan payments, and related information. For example, a loan tab 108 can display the amount of loan payments and additional principal-only payments for participants who have borrowed from their retirement plan. Other embodiments of the invention may not use tabs to organize information.

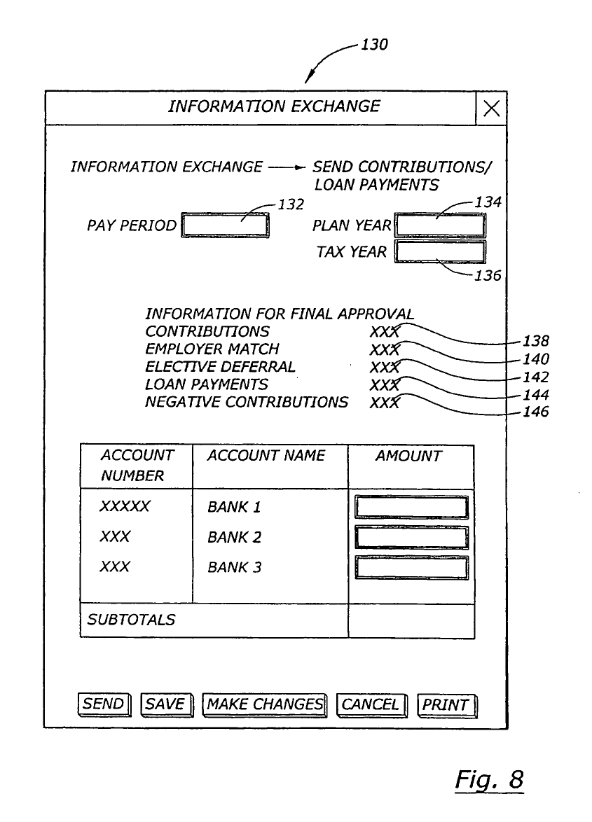

FIG. 8 illustrates a send contributions confirmation web page 130. In one embodiment, the send contributions confirmation web page 130 can display the pay period 132, the plan year 134, and the tax year 136. For a particular pay period, information concerning the amounts of contributions 138, employer matching contributions 140, elective deferrals 142, loan payments 144, and negative contributions 146 can be displayed. This can provide a plan sponsor the opportunity to review the contribution information before making an electronic funds transfer that sends the contributions and loan payments from a bank account associated with the plan sponsor to a bank account associated with the plan provider. The plan sponsor can have multiple bank accounts from which the contributions or loan payments can be transferred. Some embodiments of the invention permit the plan sponsor to divide a total contribution amount between multiple bank accounts. If the plan sponsor agrees with the contribution totals, the plan provider can transfer the corresponding amount through an electronic funds transfer request.

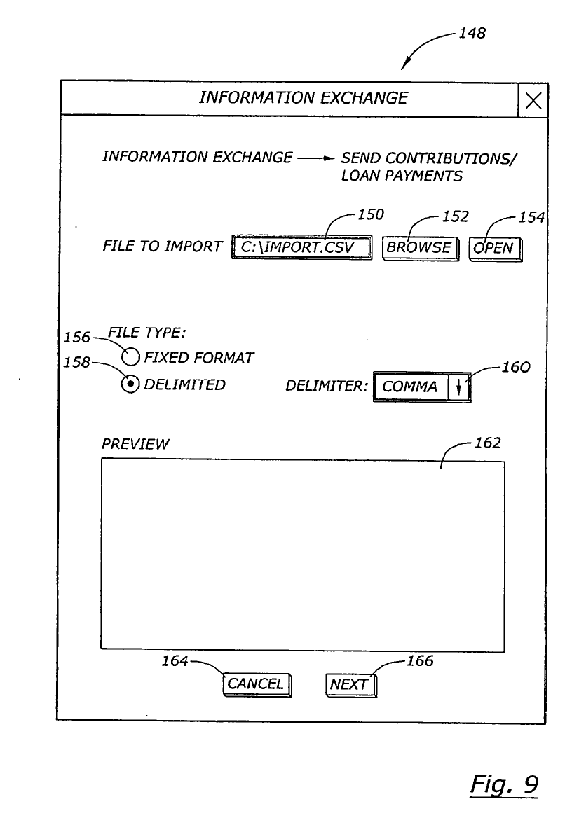

In some embodiments of the invention, instead of requiring the plan sponsor to enter the contribution and loan payment amounts manually into the information exchange web site, the plan sponsor can also import a file containing the necessary information. For example, the plan sponsor's internal accounting software can generate a file that contains all the required information. For example, the plan sponsor can use a spreadsheet application to conduct the plan sponsor's accounting. Spreadsheet applications and accounting applications can allow a user to save or export information to another file, such as a comma separated value (csv) file or other such file. Some embodiments of the invention permit a plan sponsor to import a pre-existing file containing contribution and loan payment information. This simplifies the information exchange process for the plan sponsor as this information does not need to be manually re-entered into the information exchange web site. The plan sponsor need only save the required information in a delimited file and then import the file into the information exchange web site. Referring to FIG. 9, the plan sponsor need only select the file to import through entering the file name in text box 150 or selecting a file through the use of a browse button 152. Once the file is selected, the user can press the open button 154. The plan sponsor can then select the type of file that is being imported. For example, the plan sponsor can use a fixed format file associated with a radio button 156 or a delimited format file associated with an option button 158. If the file type is delimited, then the plan sponsor can use the drop-down list box 160 to select the particular delimiter that is used. Common delimiters include commas, semi-colons, spaces, and tabs.

In some embodiments of the invention, the user can specify text qualifiers such as double quotes or single quotes that can be used to set off data contained in the import file. In addition, there can be headers and/or footers contained in the import file so the plan sponsor can select the row to begin the import and the row to end the import so that the header and footer information, which is not desired, is not imported. To aid in the process of selecting the proper import parameters, a preview box 162 can also be used that contains the file data or the file data associated with a previously-imported file. Once the import parameters are selected, the plan sponsor can either cancel by selecting the cancel button 164 or proceed with the import by selecting the next button 166. The data can be verified prior to being imported. In addition, if any errors occur in the import process, the plan sponsor can be informed. The file format of the import file can also be saved so that in future imports, the plan sponsor need not adjust the file type information.

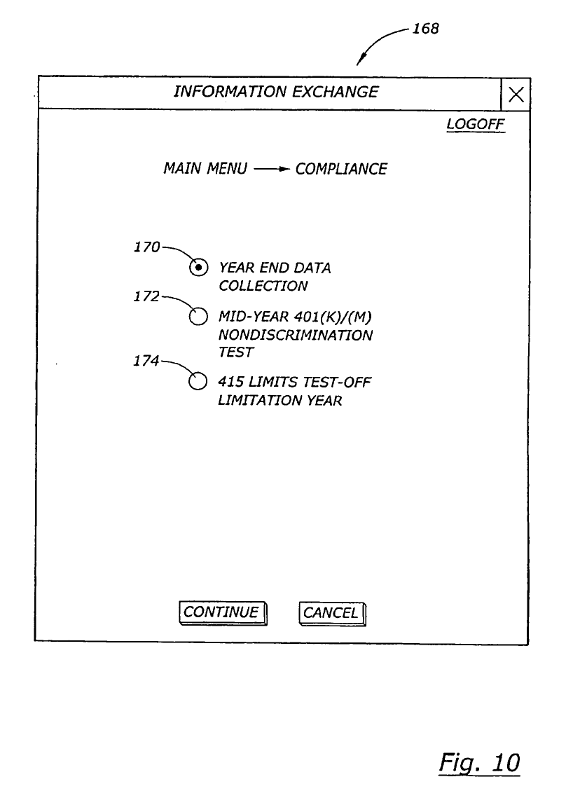

FIG. 10 illustrates a compliance selection web page 168. Using the compliance selection web page 168, a plan sponsor can select a type of compliance test to perform. Compliance tests are used to determine whether a particular benefit plan meets certain government requirements. In some embodiments of the invention, numerous types of compliance tests and compliance filings can be used as required by a government entity or the plan sponsor. In one embodiment, three such compliance related tests include a plan year-end data collection that can be selected through an associated option button 170, a mid-year 401(k)/(m) non-discrimination test that can be selected through an associated option button 172, and a 415 limits test-off limitation year that can be selected through an associated option button 174. In some embodiments of the invention, multiple tests can be performed at the same time. For example, in the case of a plan year-end data collection, tests such as a top-heavy test, a coverage test, a 401(k)/(m) non-discrimination test, and an IRS form 5500 annual report can all be performed.

A top-heavy test is a test to see if the retirement plan meets qualification requirements for a given plan year. A retirement plan is considered top-heavy when key employees hold more than a certain percentage (i.e., 60%) of the total retirement funds in their accounts. The significance of a top-heavy plan is that when a retirement plan is top-heavy, faster vesting requirements may apply. If a retirement plan is top-heavy, a minimum contribution may be due.

A coverage test can be performed to determine if the retirement plan meets minimum coverage rules associated with internal revenue code section 410(b). The test can be used to ensure that a particular retirement plan does not discriminate in favor of highly-compensated employees. The particular coverage test for a contribution plan can include a number of separate tests depending upon the particular retirement plan. These tests can involve testing for 401(k) provision for elective deferrals, testing for 401(m) provisions for matching contributions from sponsors and employee after-tax contributions, and testing for non-401 (k)/(m) provisions for other employer contributions and qualified non-elective contributions. A 401(k)/(m) nondiscrimination test is also used to determine whether a plan discriminates in favor of highly-compensated employees. In this type of test, the deferral and contribution percents for the highly-compensated employees can be examined. If highly-compensated employees, deferral and contribution percents exceed those of the non-highly-compensated employees by more than the limit allowed by the IRS, refunds may be necessary.

Compliance testing also includes preparation of certain reports, such as the report required for IRS form 5500 annual return/report and schedules. Some embodiments of the invention permit compliance tests and reports to be provided for particular plan years and for particular definitions of compensation, such as elective contributions, fringe benefit exclusions, other exclusions, exception 125 contributions, plan compensation, and gross compensation.

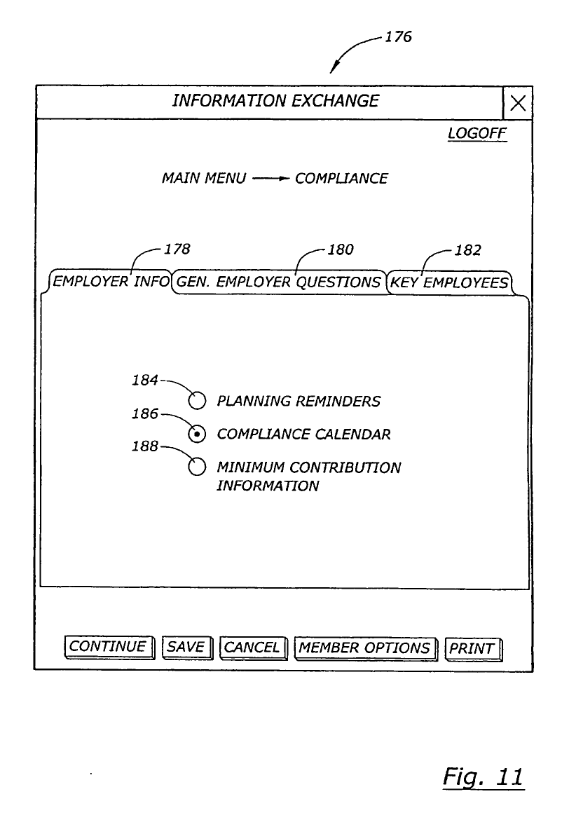

In one embodiment, in order to perform compliance tests and reports, sponsors can be allowed to review and modify information associated with the plan sponsor, plan participants, key employees of the plan sponsor, highly-compensated employees of the plan sponsor, census information associated with the plan sponsor, compensation of participants, test information, and/or form information. This collection and display of information is shown in part in FIG. 11, which illustrates a compliance information web page 176. On compliance information web page 176, there are a number of tabs with various types of information displayed on each tab. For example, an employer information tab 178 provides options for receiving additional information, such as planning reminders associated with option button 184, a compliance calendar associated with an option button 186, and minimum contribution information associated with an option button 188. Planning reminders can provide information on important topics associated with the plan. A compliance calendar can show deadlines associated with the IRS, the plan sponsor, or other deadlines. The minimum contribution information can provide additional information regarding why, when, and how to make minimum contributions. The other tabs can provide related information needed for compliance testing and for forms. Although the particular selection of this information is no way limited, common information that can be collected or required includes such information as business structure, controlled and affiliated service group information, additional plans, collectively-bargained employees, pending items, retirement plan operation changes, compensation associated with highly-compensated employees, compensation associated with key employees, census information, compensation associated with all employees, other contributions made by all employees, additional testing information, and additional information such as may be required by the Internal Revenue Service or other government agency, the plan provider, or other reasons.

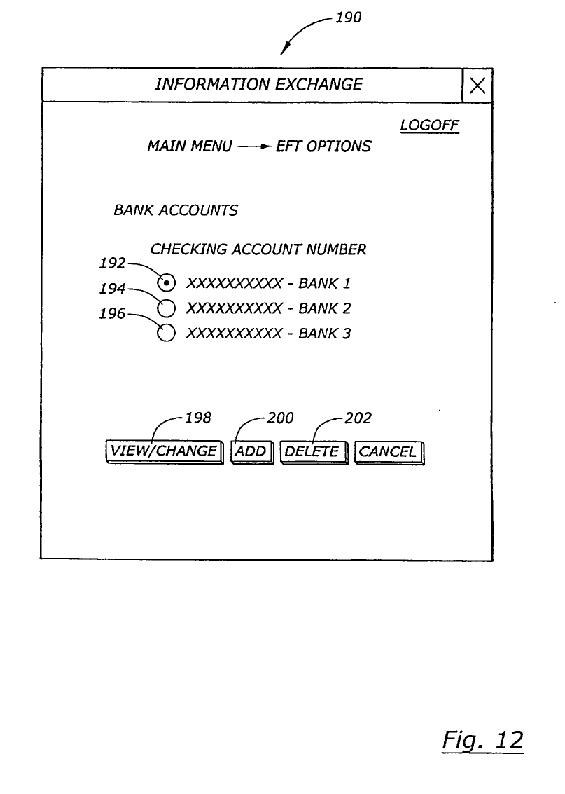

Some embodiments of the invention also provide for sponsors to add or change information associated with electronic funds transfers. FIG. 12 illustrates electronic funds transfer options web page 190, which can provide sponsors the opportunity to select which banking accounts are available for use for electronic funds transfers. For example, a plan sponsor can select a first bank account number associated with the first bank by selecting a first account option button 192, a second bank account number associated with a second bank by selecting a second account option button 194, or a third bank account associated with a third bank by selecting a third account option button 196. Some embodiments of the invention permit sponsors to view or change bank account information by selecting a view/change button 198, to add new bank accounts by selecting an add button 200, or to delete bank accounts by selecting a delete button 202. In some embodiments of the invention, a plan sponsor can have multiple bank accounts at multiple banks, and the plan sponsor can use any one or a combination of different bank accounts to make electronic funds transfers.

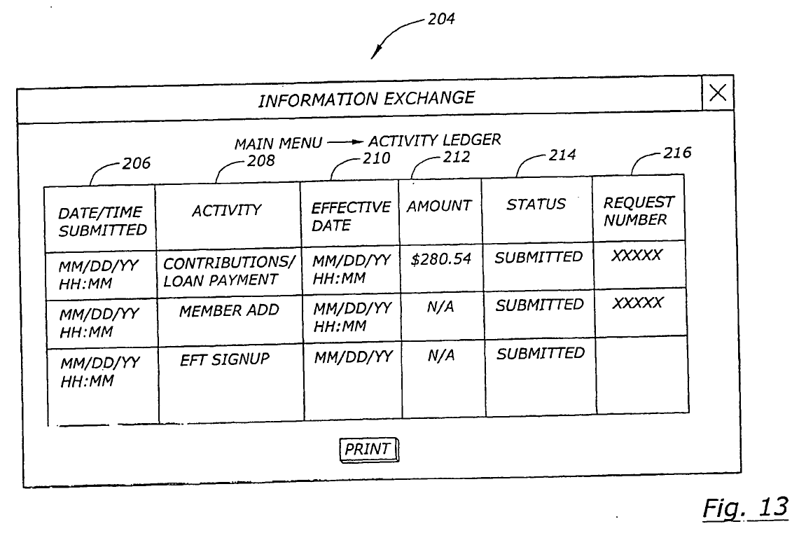

FIG. 13 illustrates an activity ledger web page 204. The activity ledger web page 204 can permit the plan sponsor to review recent activities conducted by the plan sponsor on the information exchange web site. The activity ledger can include a column date/time 206 with the date and time associated with a particular activity. In addition, the description column 208 can include a description of the particular activity in which a plan sponsor is engaged. The effective date/time column 210 can include an effective date and time of the activity. A particular activity can be submitted on one date; however, the transaction may not be effective until a second date. The activity ledger can include an amount column 212 that shows the amount of money involved in the particular activity, if applicable. The status column 214 can allow a plan sponsor to review whether the particular activity has been performed or is pending, and a request number 216 can be associated with the submission for identification purposes, if necessary. Thus, a plan sponsor can view the activity ledger on the activity ledger web page 204 for a summary of recent submissions made to the information exchange web site. In some embodiments, examples of activities include contributions and loan payments, adding additional participants, signing up for electronic funds transfer, and other activities associated with a plan sponsor's use of the information exchange internet site.

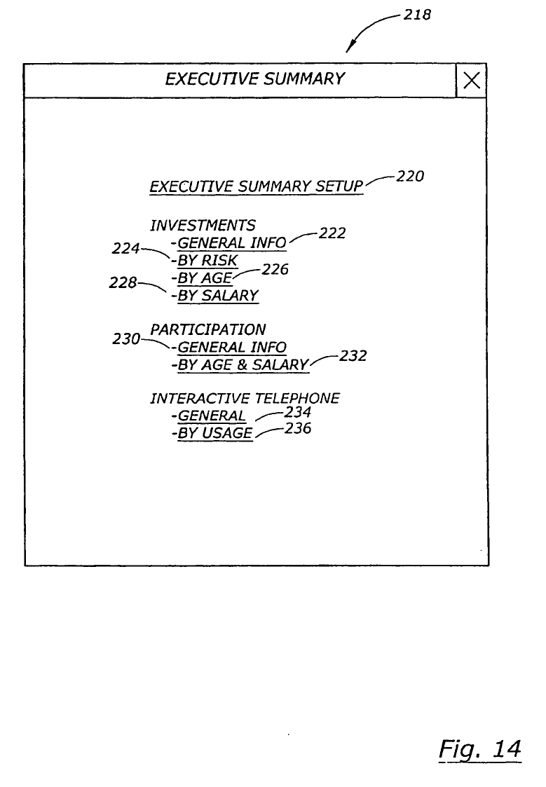

Some embodiments of the invention permit a plan sponsor to view executive summary information, such as is summarized in an executive summary web page 218, as shown in FIG. 14. The executive summary information can include settings specifying how the information should be displayed. The settings can be modified through selection of the executive summary setup link 220. In some embodiments, the executive summary information can include summarized investment information, including general information regarding investments which can be viewed by selecting the general information link 222, investment information summarized by risk which can be selected through selection of the by risk link 224, investment information summarized by age which can be viewed by selecting the by age link 226, investment information summarized by salary which can be viewed by selecting the by salary link 228. The executive summary information can also include summary information regarding participation in the group retirement plan. General information concerning participation can be viewed by selecting a general information link 230, participation information summarized by age and salary can be displayed by selecting the by age and salary link 232. Summary information can also include the summary of use of an interactive telephone service. The interactive telephone service can provide interactive voice response to requests from participants for benefit plan information. A general information link 234 can provide general information regarding the use of the interactive telephone services, and the by usage link 236 can provide summary information regarding the use of the interactive telephone service by particular usage.

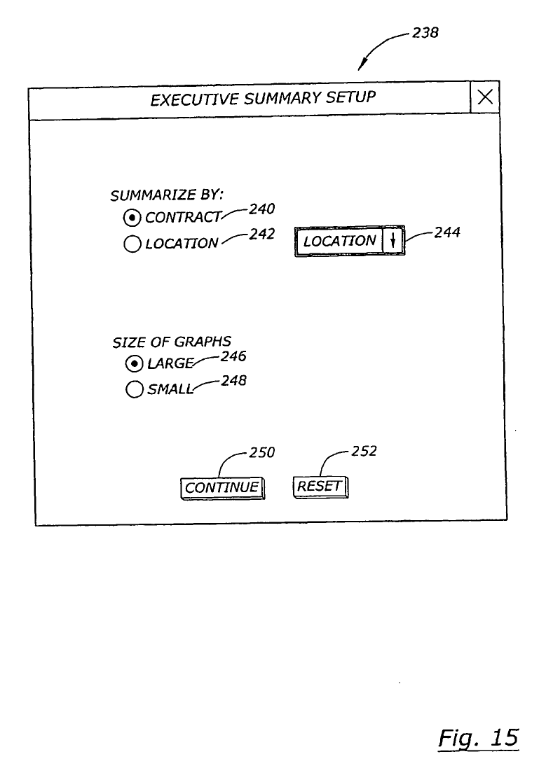

FIG. 15 illustrates an executive summary setup web page 238, which can provide sponsors with the opportunity to select the format used to summarize or to display information. For example, group retirement plan information can be summarized by contract or location. Selection of the contract option button 240 can allow a plan sponsor to select that group retirement plan information summarized by contract, and use of the location option button 242 can allow a plan sponsor to specify that the group retirement plan information should be summarized by location. When group retirement plan information is summarized by location, a plan sponsor can choose the particular location by selecting a location in the drop-down list box 244. Similarly, the plan sponsor can select attributes associated with the format or display of information. For example, the plan sponsor can select the size of graphs to be used to summarize information. The plan sponsor can select a large option button 246 to specify that large graphs should be displayed and the plan sponsor can alternatively select a small option button 248 to specify that small summary graphs should be displayed.

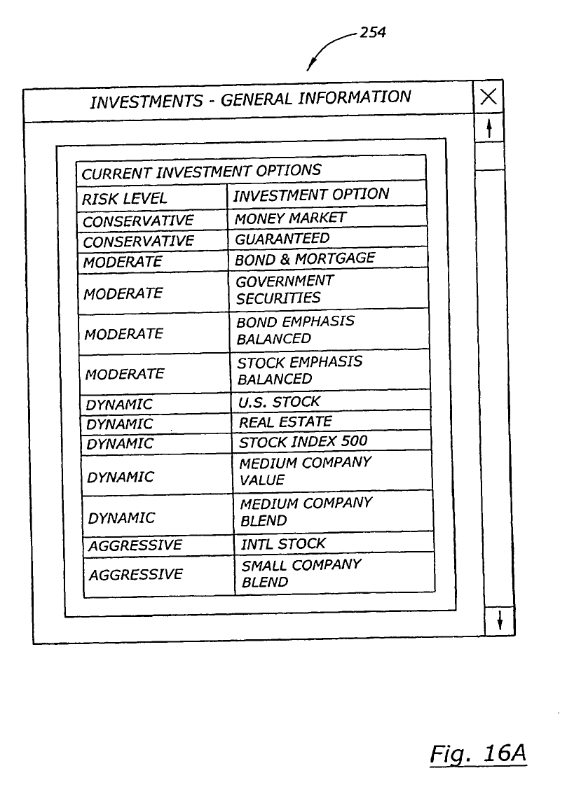

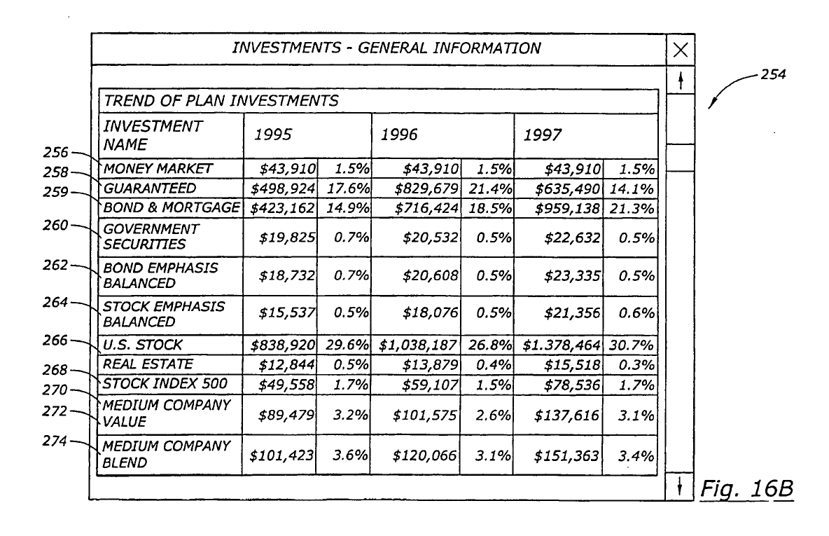

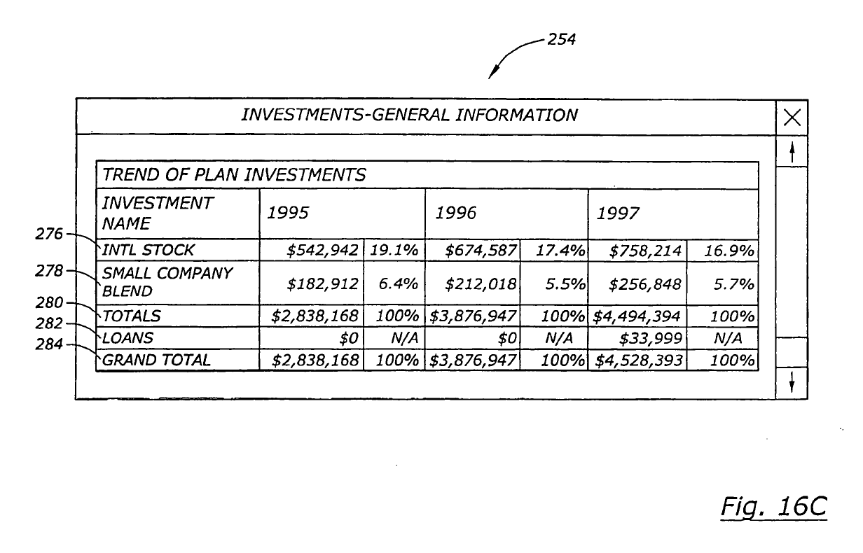

In some embodiments of the invention, sponsors can be provided with general information regarding investments. FIGS. 16A-16C provide examples of types of general information that can be displayed. FIGS. 16A-16C illustrate an investment general information web page 254. In FIG. 16A, current investment options are shown, along with the risk level associated with those options. For example, a money market account can be considered a conservative option, as would a guaranteed interest investment. Bond and mortgage, government securities, bond emphasis balanced, and stock emphasis balanced investments can be considered to carry a moderate level of risk. U.S. stock investments, real estate investments, and certain mutual fund investments can be considered to carry a dynamic risk level. Other investment options, such as international stock and other mutual funds, can be considered to carry an aggressive risk level. Some embodiments of the invention do not require that investments be categorized in any manner.

FIG. 16B illustrates additional information that can be displayed on an investment general information web page 254. For example, the investment general information web page 254 can display trends of plan investments, such as trends for money market investments 256, guaranteed interest investments 258, bond and mortgage investments 259, government securities 260, bond emphasis balanced investments 262, stock emphasis balanced investments 264, U.S. stock investments 266, real estate investments 268, and stock fund investments 270, 272, and 274. For each investment, the amount of money invested in that investment by the group can be shown, along with the corresponding percentage of the total investment.

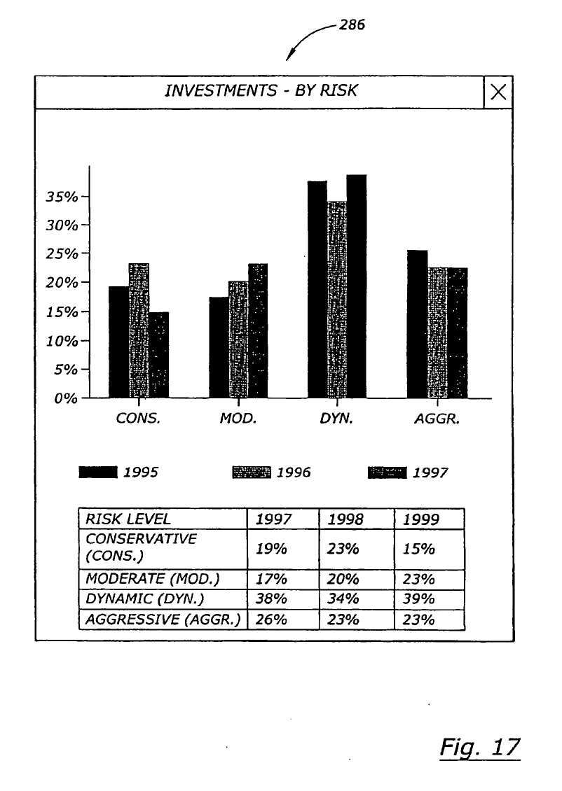

FIG. 17 illustrates a web page 286 which displays summarized investment information by risk. Types of risk can include conservative risk, moderate risk, dynamic risk, and aggressive risk. A bar chart or other graph or chart can display this summarized information. Some embodiments of the invention do not require that the types of risk be shown or categorized in any manner.

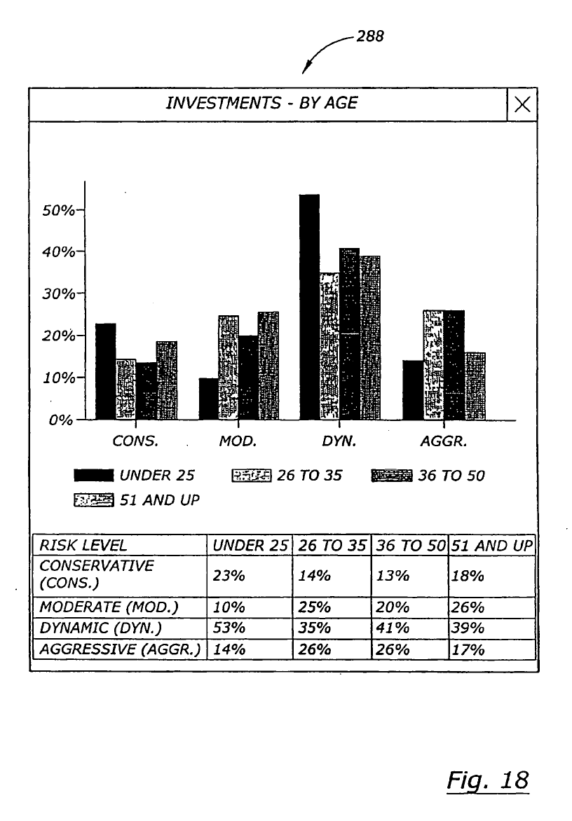

Similarly, FIG. 18 illustrates an investments by age web page 288 that displays investments by age. The investments by age web page 288 can include both a graph, such as a bar graph or chart of investment risk, and the percent invested, and can also group each type of risk by age. This can permit a group retirement plan sponsored to determine the type of risk level in which each age group invests.

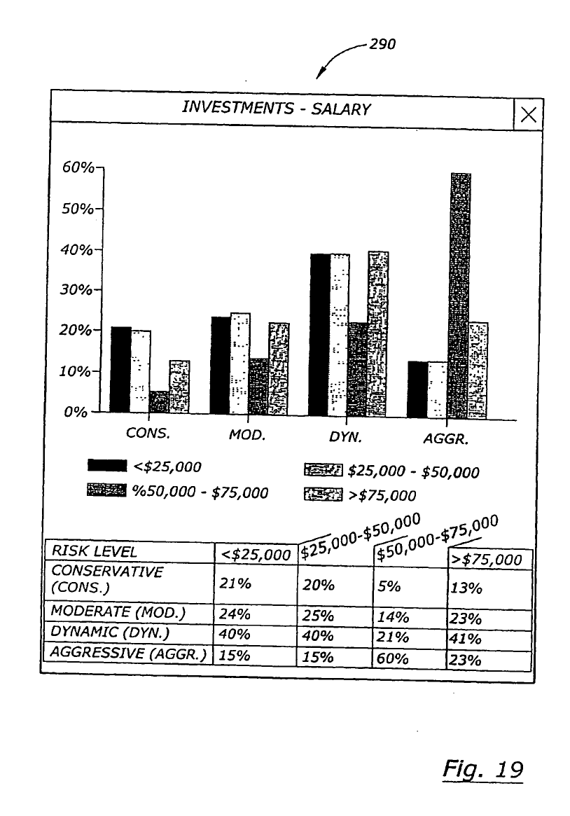

FIG. 19 provides similar summary type information in an investment by salary summary web page 290. The risk level associated with each range of salaries is shown in FIG. 19 so that the plan sponsor can view the relationships between the risk level and salary.

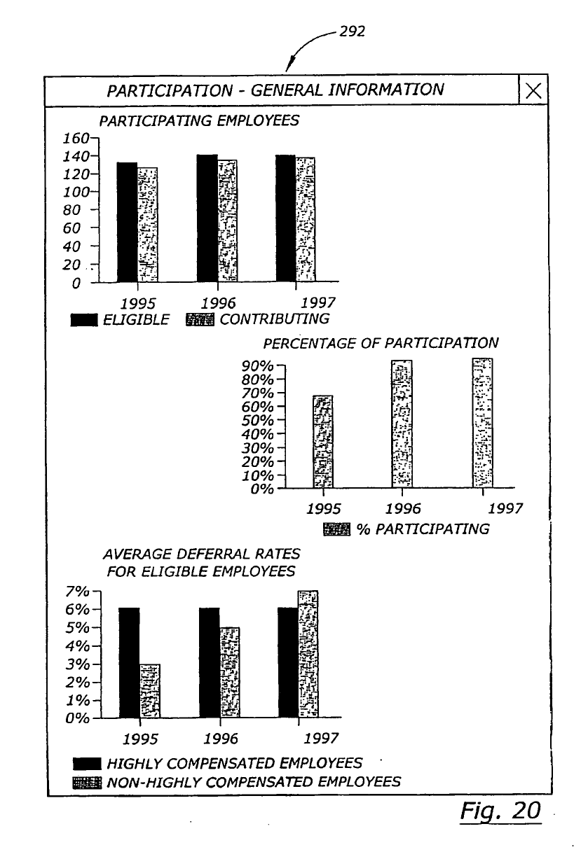

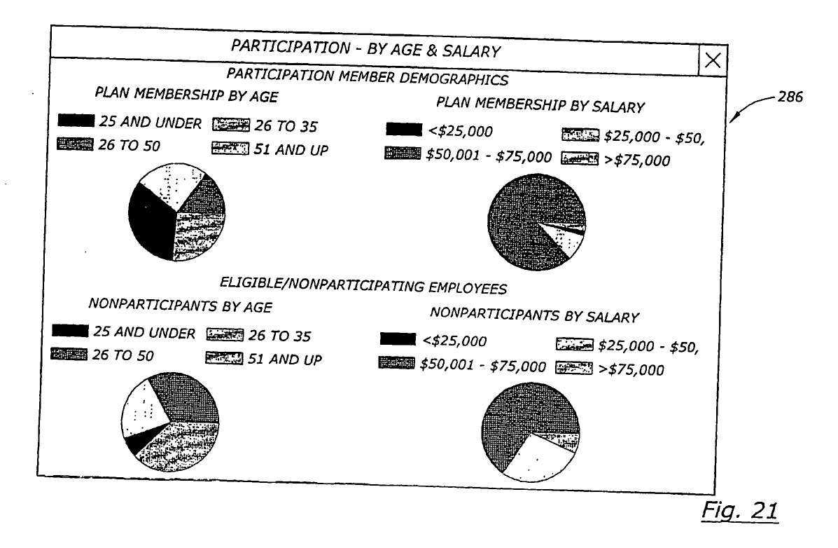

The executive summary information can also include summaries of participation, such as in a group retirement plan. FIG. 20 illustrates a participation general information web page 292, which can allow the plan sponsor to see the level of participating employees in a benefit plan among those eligible to participate in a plan, the change in participation ranked over time, and/or the average deferral rates for eligible employees. Similarly, FIG. 21 illustrates a participation by age and salary summary web page 294, which can provide sponsors with summaries of participation member demographics based on the age of participants or the salary of participants. In addition, the participation by age and salary summary web page 294 can summarize eligible but non-participating employees by age and salary. In some embodiments of the invention, other types of information that may be useful or desirable to a plan sponsor can be included in the summary information.

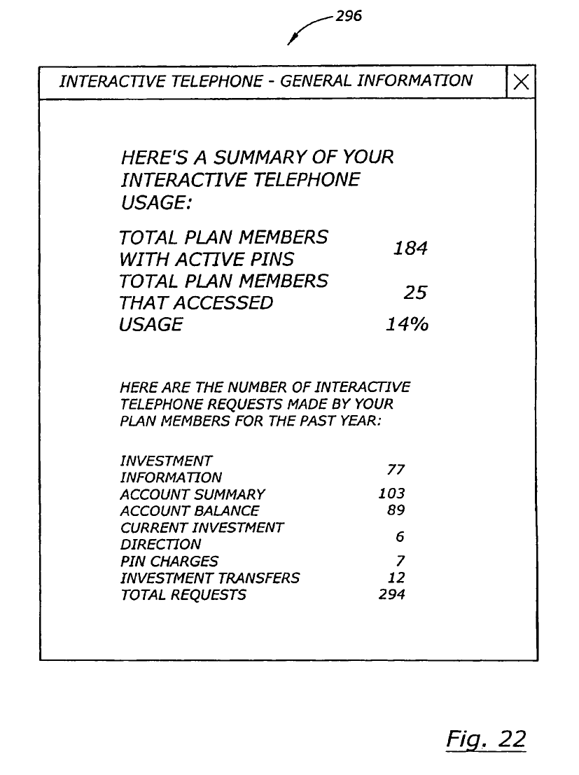

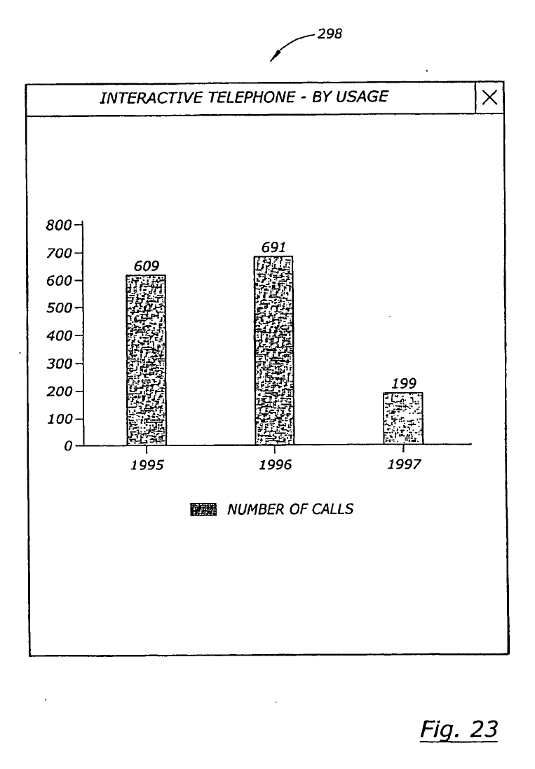

A plan provider can also provide an interactive telephone service that can permit benefit plan participants to call in to request information regarding their benefit accounts using an automated system. FIG. 22 illustrates an interactive telephone general information web page 296, which can include a summary of usage of interactive telephone services. This can provide a plan sponsor with a summary of the total number of participants with active PINs that potentially could use the system and/or the total number of plan participants that actually access the system. In addition, the total number requests associated with the interactive telephone service can be shown. This shows the plan sponsor the type of request made by plan members and the number of requests made. Similarly, FIG. 23 illustrates an interactive telephone by usage summary web page 298.

In some embodiments of the invention, information sent to and received by the plan provider can be in numerous formats and can be displayed in numerous manners. The invention is in no way limited to a particular type of formatting or display.

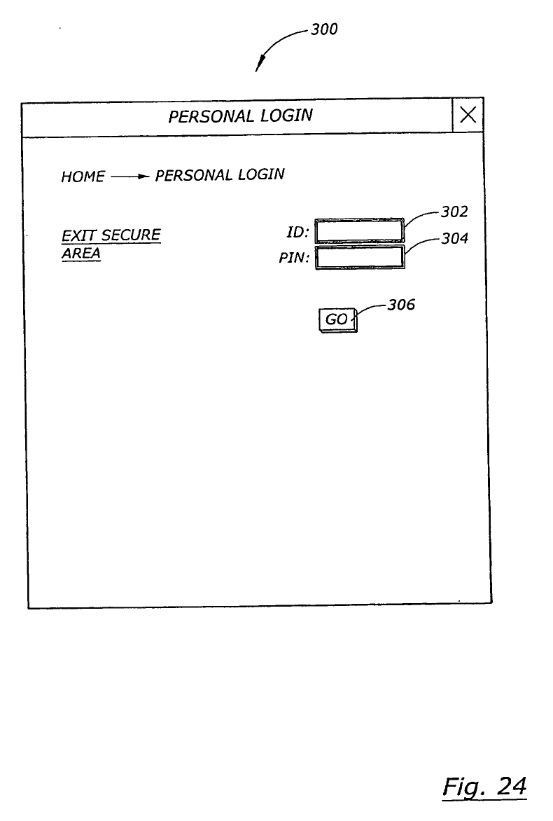

Some embodiments of the invention permit participants, who may be employees of a particular sponsor, to access their benefit plan information from a plan provider. In order to access this information, a plan participant can log on to a benefit plan provider web site. FIG. 24 illustrates a personal log-in web page 300. The plan participant can enter an ID in a text box 302 and a PIN associated with that ID in a PIN text box 304. A plan participant can then select a go button 306 to log-in. In some embodiments of the invention, the transmission of the ID and the PIN can be encrypted or otherwise made secure. The HTTPS or other secure protocol can be used, as well as other security techniques or measures.

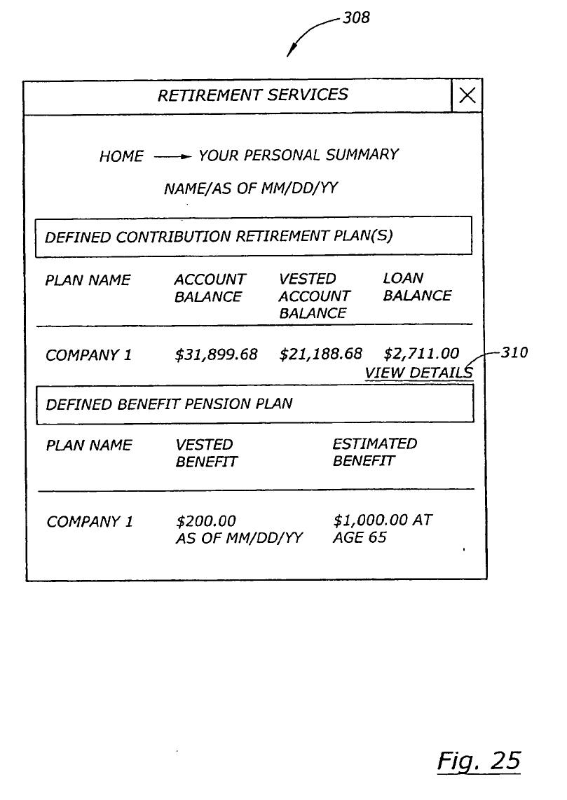

After logging in, the plan participant can be shown a personal summary of retirement plan information, such as shown in FIG. 25. FIG. 25 illustrates a retirement services summary web page 308. In one embodiment, the retirement services summary web page 308 shows different retirement plans, such as contribution retirement plans and defined benefit and pension plans, in which a particular participant may be currently enrolled. A particular retirement plan can also provide a link to detailed information, such as is shown by a view details link 310.

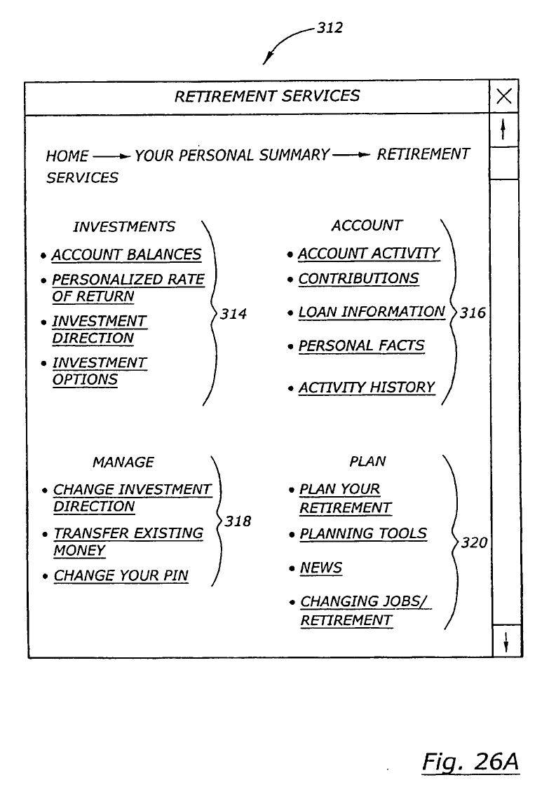

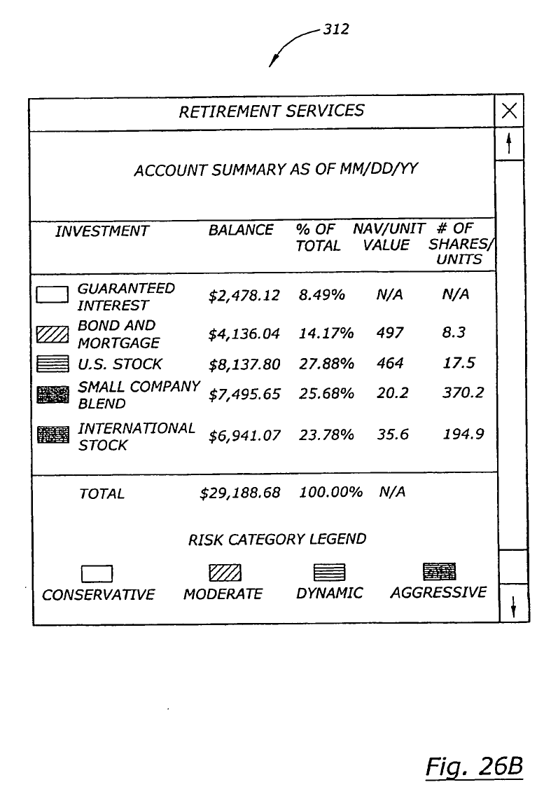

Detailed information regarding a particular individual's benefit plan can be shown in a detailed retirement plan summary web page 312, as illustrated in FIGS. 26A-26B. The detailed retirement plan summary web page 312 can include links to information regarding investments 314, account information 316, management actions 318, and planning information 320. In some embodiments, the detailed retirement plan summary web page 312 can include an account summary showing the types of investment in which the plan participant invests, the balance of each type of investment, the percent of the total value of a retirement plan invested in a particular investment, the value of units or shares associated with a particular investment where applicable, and the number of shares or units associated with a particular investment where applicable.

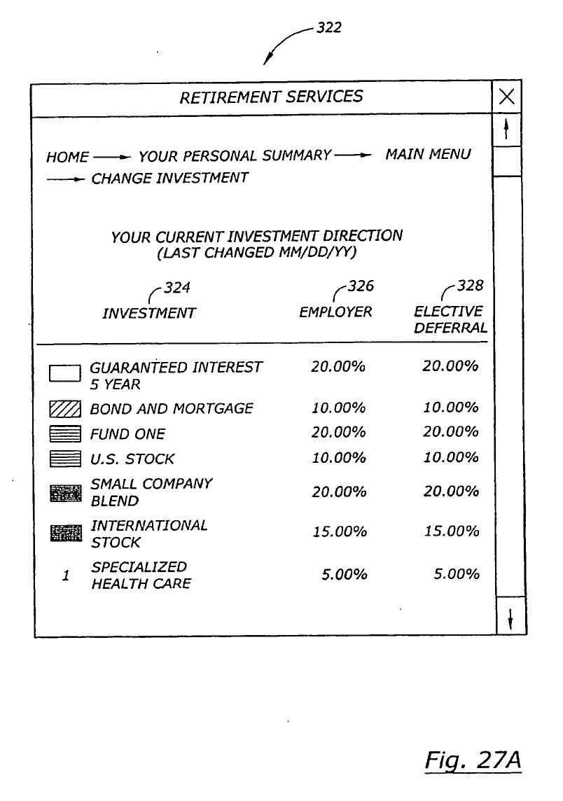

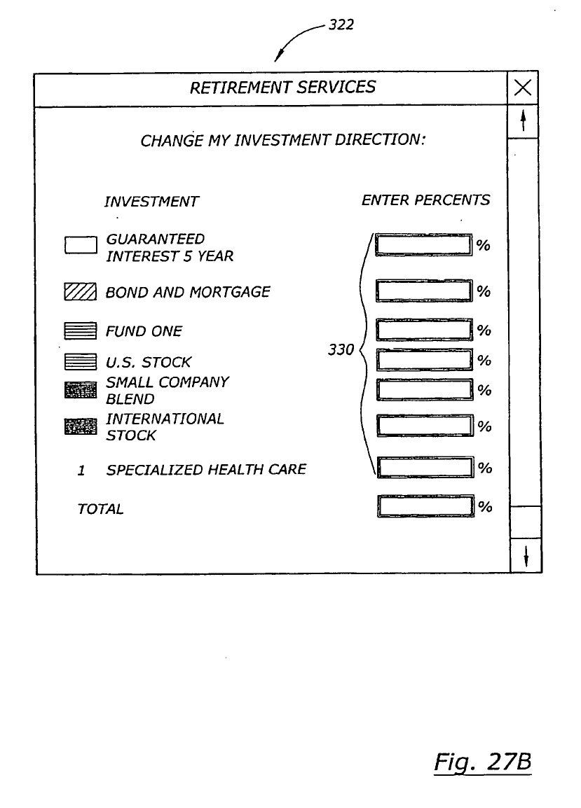

Some embodiments of the invention provide the plan participant not just with information concerning an account, but with the ability to update the information and change information, such as investment direction, and to transfer existing money from one type of investment to other types of investments. FIGS. 27A and 27B illustrate a retirement services change investment web page 322. The change investments web page 322 can list types of investments in a column 324, the percentage of employer contributions that should be directed to that particular investment in a column 326, and the percentage of elective deferrals that should be directed to that particular investment in a column 328. As shown in FIG. 27B, the change investments web page 322 can also permit a plan participant to change their investment direction by entering a percentage for each type of investment. Percentage text boxes associated with investments 330 allow a plan participant to enter new percents for each investment type. A total is also shown in FIG. 27B, the total being 100%.

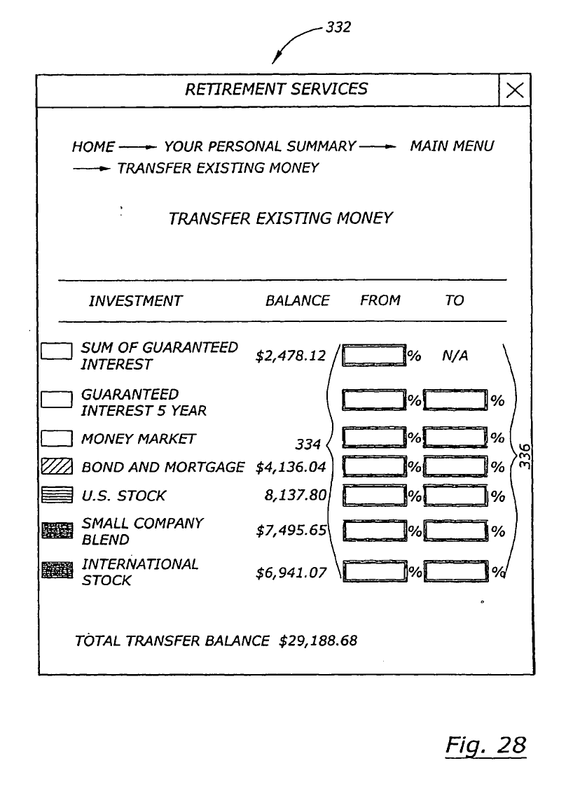

In addition to changing investment direction, a plan participant can transfer existing money from one type of investment to a second type of investment. FIG. 28 illustrates a transfer existing money web page 332. In one embodiment, in the transfer existing money web page 332, a plan participant can be provided with the types of investments, the balance for each type of investment, and the option to change from a particular percentage of the total balance in a retirement account to a new percentage of the total balance in the retirement account. In this manner, percent values in a “from” columns 334 can be changed to different percent values in a “to” columns 336.

In some embodiments of the invention, the transfer of existing money can be by dollar amounts as well as percentage values. In addition, this transfer of money can be by money type, for example, by plan participant deferral or by sponsor matching.

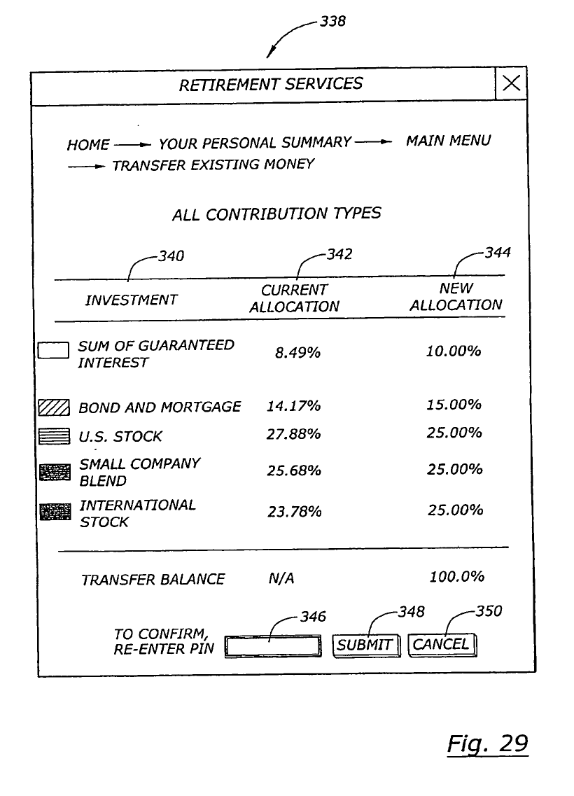

Some embodiments of the invention permit a benefit plan participant to rebalance money. For example, a rebalance of money in a retirement account may be appropriate where a plan participant has invested in a number of different types of investments and is contributing a particular percentage value to each investment. Then, due to market fluctuations or shifts, the amount of the total value of the retirement account is not related to the amount of the percentage originally allocated to a particular type of investment. In this situation, a group retirement plan participant may desire to rebalance money in their account to change the percentage of the retirement account balance from a current allocation to a new allocation. As shown in FIG. 29, the rebalance web page 338 can include an investment column 340, a current allocation column 342, and a new allocation column 344 that can show for each investment the current allocation and the new allocation. The plan participant can then confirm the rebalance action by re-entering their PIN in a text box 346 for security purposes. The retirement plan participant can then submit the rebalance changes to the group retirement plan provider by selecting a submit button 348 or can cancel the rebalance action by selecting a cancel button 350. The plan participant can also schedule the rebalance transaction to occur quarterly.

The information flow of some embodiments of the invention has been described in detail by showing the types of information exchanged between benefit plan providers and sponsors, and between benefit plan providers and participants. In some embodiments, this information is exchanged through use of an Internet web site. In addition, there can be information flow related to the benefit plan provider.

There are many different variations in which embodiments of the invention can be implemented. In particular, validation of the information can occur at various stages in the process, such as by applets running on a client PC, programs running on a web server, and by a mainframe. Once the information received from a plan participant or plan sponsor is in the system and validated, the plan provider can act upon that information. For example, once a plan participant sends information regarding modifications to the plan participant's investments, the plan provider's system can act accordingly by performing electronic securities transactions or other actions that a plan provider may typically perform once it receives information from plan participants or plan providers.

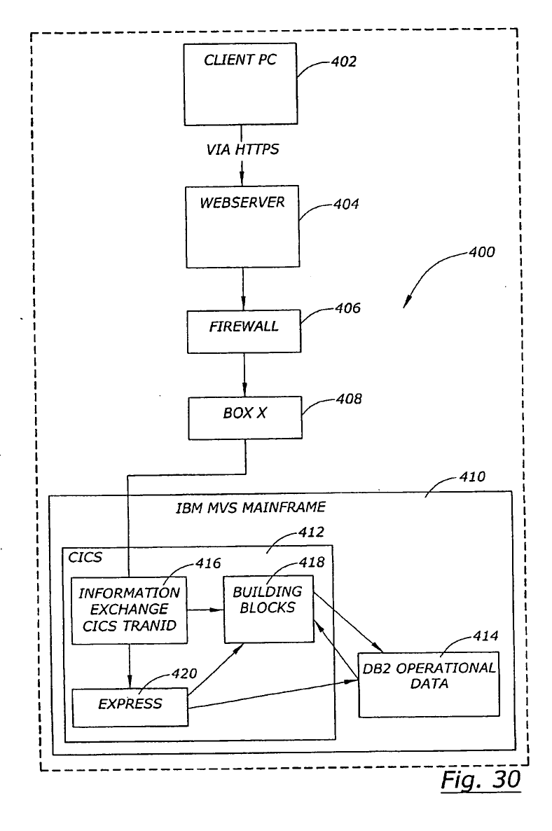

FIG. 30 illustrates one embodiment of a system of a benefit plan provider. A client PC 402 can communicate with a web server 404 associated with a benefit plan provider. A benefit plan provider's web server 404 can communicate with the plan provider's internal systems. To protect the plan provider's internal data, a firewall 406 can be used. Box X 408 can be a device that filters and directs traffic to and from a mainframe 410. The mainframe 410 can read and write to a database 414.

In some embodiments, the client PC 402 can be a personal computer using a Microsoft Windows operating system. The client PC 402 can use an internet browser, such as Microsoft Internet Explorer or Netscape Navigator. The web browser used by the client PC 402 can be capable of viewing hypertext markup language (HTML) and capable of executing JAVA applets. In addition, the web browser used by the client PC 402 can be capable of communicating using a secure HTTP protocol (HTTPS).

In some embodiments, the web server 404 can operate under a UNIX operating system. The web server can be capable of running one or more common gateway interface (CGI) programs associated with the system. The CGI programs can be written in any number of computer languages, including C++. The CGI programs may be used to connect to the mainframe 410 for data retrieval and data validation purposes. The CGI programs can also serve the HTML pages with embedded JAVA applets.

The firewall 406 can be any number of commercially-available firewall products. The firewall can be used to protect against unauthorized access to the mainframe 410.

In some embodiments, box X 408 can be used, because the web site for the service provider may have many different functions and applications and may serve many different business units. For example, a service provider can provide record keeping and other services relating to pensions, banking, brokerage services, and other services. When this is the case, incoming communications need to be directed to the correct business unit. This can be accomplished by using a communications protocol in which each business unit or application has an associated header. Data streams can be identified by the inclusion of the header information, so that box X 408 can direct the information to the proper server or mainframe.

In one embodiment, the mainframe 410 can be an IBM MVS mainframe computer. The mainframe 410 can run a Customer Information Control System (CICS) shared operating environment. Within the CICS environment, a transaction name (tranid) can be associated with the task of performing an information exchange. A COBOL program can be used to interpret the request. The COBOL program can be used to perform retrieval from the operational data storage and to perform business rule validation of the data.

The COBOL programs can use IBM's MQSeries Queue, in one embodiment, or other products to communicate between various COBOL applications running on the mainframe. This type of product enables applications to communicate regardless of the operating system or network on which the applications are running. The originating application (the Information Exchange application) can communicate with an express application by sending a message to a queue. The recipient application (the Express application) can retrieve the message from the queue.

An Express application 420 can also be a COBOL program. The express application can be a workflow system. After the request has been validated, the Express application 420 can initiate processing of the request into the operational data storage in order to speed the request process.

The Building Blocks programs 418 can be COBOL programs used to perform data retrieval from the operational data storage and to perform business rule data validation. The Building Blocks programs 418 can communicate with DB2 operational data 414. DB2 is an IBM database product. The DB2 operational data 14 can contain information related to a plan provider, a plan sponsor, or a plan participant. In this manner, information and information requests originating at the client PC 402 can be used to update or retrieve data from the database 414.

The invention is in no way limited to the particular types of computers, types of software, or specific implementation described herein. Numerous types of middleware software can be used when a web server communicates with a mainframe computer. In some embodiments of the invention, the mainframe 410, the box X 408, and/or the firewall 406 can be omitted, and the web server can directly access a database containing benefit plan information.

One embodiment of the invention provides a method, apparatus, and system that is capable of using a web-based, web-enabled front end for passing/sharing main frame data to/with a benefit plan provider. Some embodiments of the invention provide a method, apparatus, and system that provides for a comprehensive, interactive front end for providing record keeping and other service to benefit plan sponsors. Some embodiments of the invention provide a method, apparatus, and system for a comprehensive, interactive front end for providing record keeping and other services to benefit plan participants. Various embodiments of the invention provide a method, apparatus, and system for an improved way to handle both money and data relating to benefit plans. Some embodiments of the invention provide a method, apparatus, and system for the administration of benefit plans that reduces data errors, that reduces the time between receipt of a request and implementation of the request, that can automatically identify bad data, that is accessible at all times, that allows interactive editing of information, and/or that facilitates electronic fund transfers. Some embodiments of the invention provide a method, apparatus, and system for administration of benefit plans that allows two-way communication between plan sponsors and the plan provider's in-house databases and application programs, and two-way communication between participants and the plan provider's in-house databases and applications. Some embodiments of the invention provide a method, apparatus, and system for administration of benefit plans that allows plan participants to view data regarding their involvement in the plan. Some embodiments of the invention provide a method, apparatus, and system for administration of benefit plans that is customizable for each plan sponsor. Some embodiments of the invention provide a method, apparatus, and system for administration of benefit plans that is flexible, allowing, for example, direct entry of data or entry from up-loading a file. Some embodiments of the invention provide a method, apparatus, and system for administration of benefit plans that provides plan sponsors with quick, easy access to plan information, provisions, rules, and statistics. Some embodiments of the invention provide a method, apparatus, and system for administration of retirement plans that provides plan sponsors with secure, interactive two-way communication with a plan provider.

In some embodiments, the plan provider 14, the plan sponsor 16, and a number of plan participants 12 exchange information in a context other than or in addition to a retirement planning context, as described above with respect to FIGS. 1-30. FIG. 31A schematically illustrates several contexts in which information can be exchanged between the plan provider 14, the plan sponsor 16, and a number of participants 12. As shown in FIG. 31A, the plan provider 14 can provide a benefit data management system 500 that allows benefit plan information to be exchanged between the plan provider 14, the plan sponsor 16 (e.g., an employer, an organization or association, a payroll provider, etc.), and a number of participants 12 (e.g., employees, users, members, etc.). The benefit data management system 500 can provide a common platform or interface for managing benefit plan information. The benefit plan information can include retirement plan information, financial or savings plan information, work-site plan information, non-medical plan information, and/or medical plan information.

Retirement plan information can include information about retirement plans and products, such as pension plans, profit-sharing retirement plans, individual retirement account (“IRA”) plans (e.g., traditional deductible IRA plans, traditional non-deductible IRA plans, and Roth IRA plans), salary reduction retirement plans [e.g., 401(k) accounts, 403(b) accounts, Section 457 plans, thrift plans, savings plans, simple plans, Keogh plans, etc.], qualified defined benefit (“DB”) plans, qualified defined contribution plans (“DC”), stock ownership plans [e.g., qualified employee stock ownership plans (“ESOPs”)], nonqualified (“NQ”) retirement plans (e.g., NQ DB plans and NQ DC plans), etc.

Financial or savings plan information can include information about savings and investment plans and products, such salary reduction plans [e.g., 401(k) accounts, 403(b) accounts, Section 457 plans, thrift plans, savings plans, simple plans, Keogh plans, etc.], mutual fund investment plans, IRA plans (e.g., traditional deductible IRA plans, traditional non-deductible IRA plans, and Roth IRA plans), savings account plans, credit account plans, money market account plans, trust plans, future contract plans, option plans, checking account plans, college saving account plans (e.g., 529 plans), stock plans, mortgage plans, certificate of deposit plans, bond plans, annuity plans, etc.

Work-site plan information can include information about other benefit plans, such as disability plans, holiday compensation plans, vacation compensation plans, worker's compensation plans, transportation compensation plans, tenure plans, bonus plans, flexible spending account plans, childcare plans, alimony plans, child support plans, etc.

Medical plan information can include information about health or medical-related plans and products, such as HSA plans, health insurance plans, life insurance plans, dental insurance plans, vision plans, pharmaceutical plans, long term healthcare plans, Social Security plans, Medicare plans, Medicaid plans, disability plans, etc.

Non-medical plan information can include information about non-health or non-medical-related plans such as flexible spending accounts, holiday compensation plans, vacation compensation plans, worker's compensation plans, Social Security plans, transportation compensation plans, tenure plans, bonus plans, child support plans, childcare plans, alimony plans, automobile insurance plans, homeowner's insurance plans, renter's insurance plans, etc.

FIG. 31B illustrates the relationships between a plan participant 12, a plan provider 14, and a plan sponsor 16 and information flow between each entity according to one embodiment of the invention. Although only one of each entity is shown in FIG. 31B, more than one plan provider 14 can provide benefit plan-related services to more than one plan sponsor 16 and/or more than one plan sponsor 16 can provide benefit plans to more than one participant 12.

The plan sponsor 16 can exchange information with the plan provider 14. For example, the plan sponsor 16 can transmit information concerning participant information, contributions made to benefit plans of the participants 12 associated with the plan sponsor 16, loan payments made to a benefit plan participant account by participants 12 associated with the plan sponsor 16, compliance information associated with the plan sponsor 16, and banking information associated with the plan sponsor 16.

As shown in FIG. 31B, the plan provider 14 can transfer information to the plan sponsor 16. For example, the plan provider 14 can transfer benefit plan information, summaries of benefit plan information, and other reports and information, such as participation summaries, investment summaries, the results of compliance tests, and/or activity ledgers.

The plan provider 14 can exchange information with the participant 12. For example, the participant 12 can transfer participant information, changes in benefit plan information, changes in investment direction, transfers of existing money, and/or rebalancing of investment allocation to the plan provider 14. The plan provider 14 can provide summaries of benefit plan information to the participant 12.

Benefit plan information exchanged between the plan provider 14, the plan sponsor 16, and/or the participant 12 can include information from various sources. For example, the benefit plan information can include information from one or more plan sponsors 16, one or more participants 12, and one or more plan providers 14. For example, a first plan provider can obtain information regarding a benefit plan that it does not provide (e.g., a health insurance plan) from a second provider (e.g., an insurance provider, a human resources provider, a financial-services provider, etc.) and can combine the information with information regarding a benefit plan that the first plan provider does provide (e.g., a retirement plan).

In some embodiments, data provided to and/or from the benefit data management system 500 can be obtained from or through a third-party system, such as a payroll processing system (a “payroll provider”) before being provided to and/or received from a plan sponsor 16 and/or a participant 12. For example, as shown in FIG. 31A, a third-party system, such as a payroll provider, can directly provide information to the plan provider 14 and/or can indirectly provide information to the plan provider 14 through the plan sponsor 16.

As shown in FIG. 31A, the plan provider can provide secure access to the benefit data management system 500 to a plan sponsor 16, such as an employer, and a participant 12, such as an employee. In some embodiments, as described above with respect to FIG. 1, benefit plan information exchanged between a plan provider 14 and a plan sponsor 16 and between a plan provider 14 and a participant 12 can occur over a network, such as the Internet. Benefit plan information can be presented to and retrieved by a plan sponsor 16 and a participant 12 through the use of a network interface, such as a world wide web-based interface (hereinafter “browser application”). The browser application can display web pages or forms to a plan sponsor 16 and a participant 12. The web pages or forms can display information to a plan sponsor 16 and a participant 12, such as benefit plan information. The web pages or forms can also be used to obtain information, such as benefit plan information from a plan sponsor 16 and a participant 12.

As described above with respect to FIG. 30, a client PC 402 (hereinafter “client computer”) can be used by a plan sponsor 16 and/or a participant 12 in order to obtain and/or provide information, such as benefit plan information. The client computer 402 communicates with a web server 404 associated with the benefit plan management system 500, which can be managed by a plan provider 14. The server 404 can communicate with one or more systems managed by the plan provider 14. In some embodiments, in order to protect the plan provider's internal data, a firewall 406 or other security mechanism is used.

The server 404 can communicate with a mainframe computer 410 (hereinafter “computer”). The computer 410 can include one or more processing systems and devices, such as servers, databases, routers, etc., to execute and manage the benefit data management system 500. The computer 410 can store and retrieve information, such as benefit plan information, to one or more databases 414. In some embodiments, the computer 410 includes one or more systems managed by a plan provider 14. The one or more systems can include individual systems for managing individual types of benefit plan information. For example, the computer 410 can include a system associated with retirement plan information, a system associated with medical plan information, a system associated with financial or savings plan information, etc. The benefit data management system 500 can obtain and store benefit plan information from one or more of the systems managed or executed by the computer 410. In some embodiments, the computer 410 can communicate with external systems managed by other plan providers.

The benefit data management system 500 can provide a mechanism for a plan sponsor to collect information needed to prepare compliance tests, government filings, benefit updates, actuarial valuations, and contribution allocations. In some embodiments, the primary method for a plan sponsor 16 and/or a participant 12 to submit data is through pages or forms displayed by the benefit data management system 500 over a network, such as the Internet. An information collection process can start when a user logs on to the benefit management system 500. Based on a security profile of the user, as determined by the plan provider 14 and/or the plan sponsor 16, the user has access to zero plans or one or more plans for which the user has been granted access. The user can select one or more plans on which they wish to update information. In some embodiments, updated information, provided once by the user, can be used to update data for all plans selected by the user. Based on the plan type and services applicable to each plan, the user can be presented with questions and/or information identifying what information to submit. The questions and/or information can include plan provider-level questions that are applicable to a particular plan sponsor 16 of plans offered by a plan sponsor 16, plan-level questions that are applicable to each of the plans provided by a plan sponsor 16, participant questions/data requests, participant information common to all plans (e.g., data of birth, gender, date of hire, etc.), and participant information specified to each plan. The benefit data management system 500 can validate the information (e.g., based on defined rules) before submitting or storing the information.

Information can be validated at various stages, such as by applets running on the client computer 402, by programs running on the server 404, and by programs executing on the computer 410.

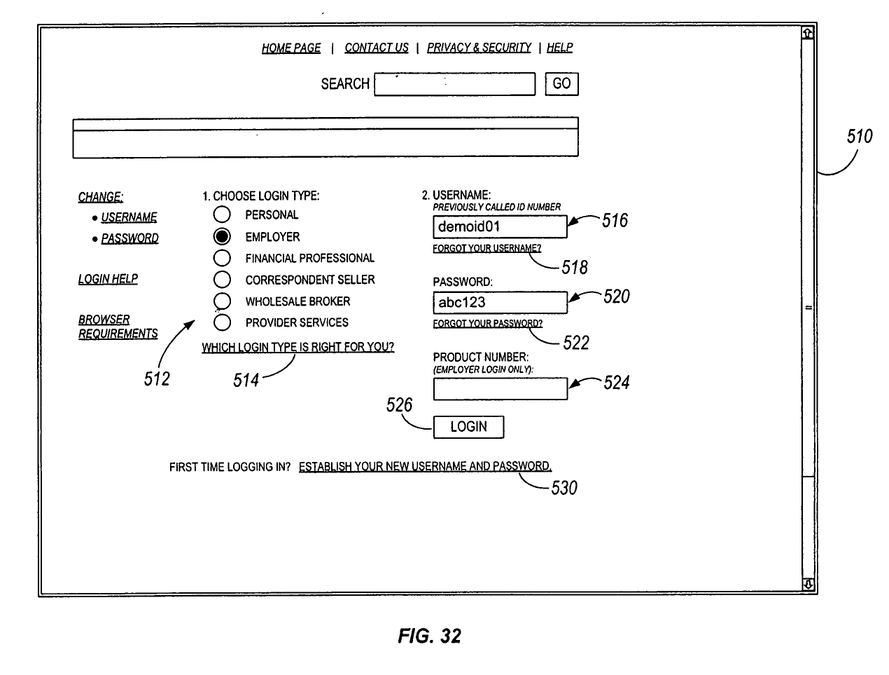

In order to access the benefit data management system 500, the server 404 can communicate with the computer 410 (or other systems of managed by the plan provider 14) in order to display a login page 510, as shown in FIG. 32, on the client computer 402. The login page 510 can include a login type selector 512 that allows a plan sponsor 16 and/or a participant (hereinafter a “user”) to select a type of log-in. As shown in FIG. 32, the login type selector 512 can include a radio button. Other selection mechanisms can also be used.

In some embodiments, the benefit data management system 500 can provide personalization. For example, the login page 510 and/or other pages displayed by the benefit data management system 500 can be customized in order to target appropriate communication. For example, pages and forms displayed by the benefit data management system 500 can be customized for particular plan sponsors 16 and/or participants 12 and can include logos and/or other graphics, text, formats, etc. specific to a particular plan sponsor 16 and/or participant 12.

A user can use the login type selector to select a login type from among a variety of login types. For example, a user can use the login type selector to select a personal login type, an employer login type, a financial professional login type, a correspondent seller login type, a wholesale broker login type, and a provider services login type. In some embodiments, the login page 510 can include one or more type description links 514 that a user can select (e.g., click) in order to obtain descriptions of available login types and suggestions for which login type to select. Providing the login type selector 512 can allow the plan sponsor 16 to provide a single login page for various types of users logging on to the benefit data management system 500 or other systems managed by the plan provider 14.

The login page 510 can include a username or identification number entry mechanism 516 that a user can use in to enter a username or an identification number. In some embodiments, the login page 510 can include a forgot your username link 518. A user can select the forgot your username link 518 if he or she has forgotten their username. Selecting the forgot your username link 518 can display information to the user about obtaining their username, resetting their username, and/or obtaining a new username. In some embodiments, selecting the forgot your username link 518 can prompt a user to answer one or more security questions before being allowed to obtain or reset their username.

The login page 510 can include a password entry mechanism 520 that a user can use to enter a password or other security code. In some embodiments, the login page 510 can include a forgot your password link 522. A user can select the forgot your password link 522 if he or she has forgotten their password. Selecting the forgot your password link 522 can display information to the user about obtaining their password, resetting their password, and/or obtaining a new password. In some embodiments, selecting the forgot your password link 522 can prompt a user to answer one or more security questions before being allowed to obtain or reset their password.

As shown in FIG. 32, the login page 510 can include a product number entry mechanism 524 that a user (e.g., a plan sponsor 16) can use to enter a product number. The product number can include a particular system managed by the plan sponsor 16 and/or a particular plan or product provided by the plan sponsor 16 (e.g., retirement plans). The product number can also indicate a contract number associated with a contract established between a plan provider 14 and the plan sponsor 16 and/or the plan provider 14 and a participant 12.

After selecting a login type, entering a username, and entering a password, a user can select a login button 526 on the login page 510 in order to submit the information provided in the login page 510 to the server 404 and the computer 410.

The computer 410 and/or the server 404 can validate the login type, the username, the password, and/or the product number submitted by a user. If the login type, the username, the password, and the product number (if applicable) are validated the user is allowed access to additional pages provided by the benefit management system 500.

In some embodiments, to obtain a valid username and password, a user can establish an account with the plan provider 14. In some embodiments, a user can meet with a client services associate of the plan provider 14 in order to set up a username and password (e.g., to establish a user as a primary security administrator). In other embodiments, a user can set up a username and password electronically using the login page 510. As shown in FIG. 32, the login page 510 can include an establish new username and password link 530. Selecting the establish new username and password link 530 can display one or more setup pages. The setup pages can guide the user through setting up a username and a password. In some embodiments, the setup pages can prompt a user to enter identifying information (e.g., name, social security number, etc.) and/or a security code (e.g., a contract number, an access number, a group number, a plan number, a portfolio number, etc.). If the identifying information and the security code (if applicable) is validated, a user can be allowed to establish a username and a password that can be used on the login page 510 to access the benefit data management system. In some embodiments, a user can go through a similar process to reset a username and/or password.

The web pages and forms of some embodiments of the invention can be secured in a suitable manner. Security can be added through a number of different methods. For example, security can be added through implementation of the secure sockets layer (“SSL”) protocol or other protocols that implement public/private keys, digital certificates, and other security measures aimed at providing authentication. Similarly, other security protocols or measures can be used.

Once a user has provided a valid username and password, the user can view and provide information to the benefit data management system 500. As described with respect to FIGS. 1-30, a plan sponsor 16 can add or change participants, send cash or loan contributions and submit compliance testing data. In some embodiments, data submissions are edited or validated by the server 404, the computer 410, or another validating system, while the plan sponsor 16 waits in order to ensure that data that is submitted is ready for processing.

The benefit data management system 500 can provide plan contributions management and loan management that allows a plan sponsor 16 and a participant 12 to manage one or more benefit plans, such as a retirement account. The benefit data management system 500 can provide contribution reporting, loan reporting, and loan payment warning displays. The benefit data management system 500 can calculate loan payoff amount by participant, import contributions and loan payments (e.g., with a particular file format, such as a comma separated or Lotus® fixed file). The benefit data management system 500 can perform contribution and loan reporting for inactive participants. In some embodiments, the benefit data management system 500 can include the ability to send negative contributions and report multiple loan payments for one pay period. The benefit data management system 500 can perform forfeitures as contribution offset, electronic funds transfers (EFTs), and multiple EFTs. The benefit data management system 500 can provide an online reporting application that offers a variety of reports with benefit plan information.

Plan sponsors 16 and/or participants 12 can use the benefit data management system 500 to perform cash or loan contributions to one or more benefit plans. For example, a plan sponsor 16 and a participant can provide a contribution a retirement plans and/or a HSA of the participant 12. In some embodiments, the benefit data management system 500 can require EFTs for cash transactions and can default expense payments to EFTs. Plan sponsors 16 and/or participants 12 can use the benefit data management system 500 to set up automatic cash or loan contributions. For example, plan sponsors 16 and/or participants 12 can select a date when automatic cash or loan contributions should be made.

The benefit data management system 500 can also give participants the ability to see the costs of taking a loan. The costs can show lost earnings and/or lost contributions.

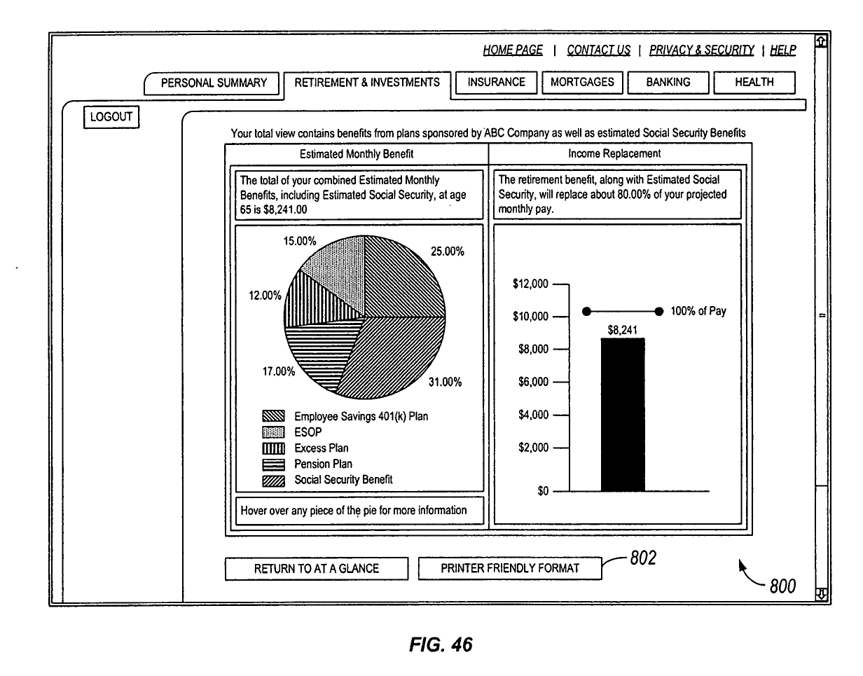

In some embodiments, plan sponsors 16 and participants 12 can use the benefit data management system 500 to determine potential benefit plan information (e.g., current and projected benefit assets) based on various benefit plan selections and benefit plan setting selections. For example, plan sponsors 16 can use the benefit management system to select benefit plans to offer, select available settings for benefit (e.g., contribution levels, investment options, etc.) and can view current and potential future costs, risks, assets, etc. associated with particular selections. A participant 12 can also select benefit plans to participate in, select benefit plan settings (e.g., contribution levels, investment options, etc.) and view current and potential future costs, risks, assets, etc. associated with particular selections. As described with respect to FIGS. 46, 47A, 47B, and 48, the benefit data management system 500 can provide a summary of benefit plan information. The summary of benefit plan information can provide an indication of current benefit plan information and projected benefit plan information.

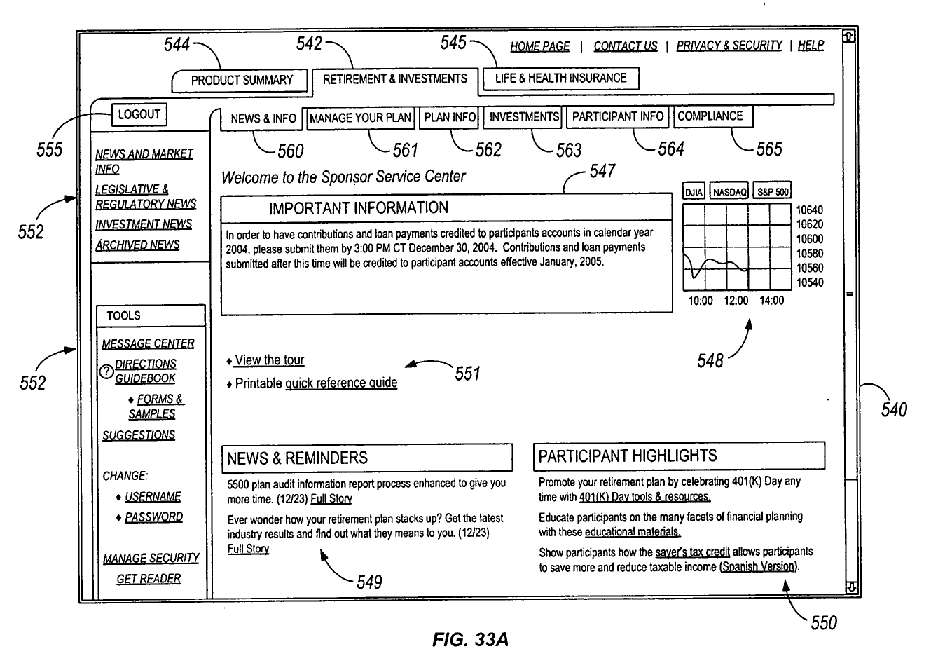

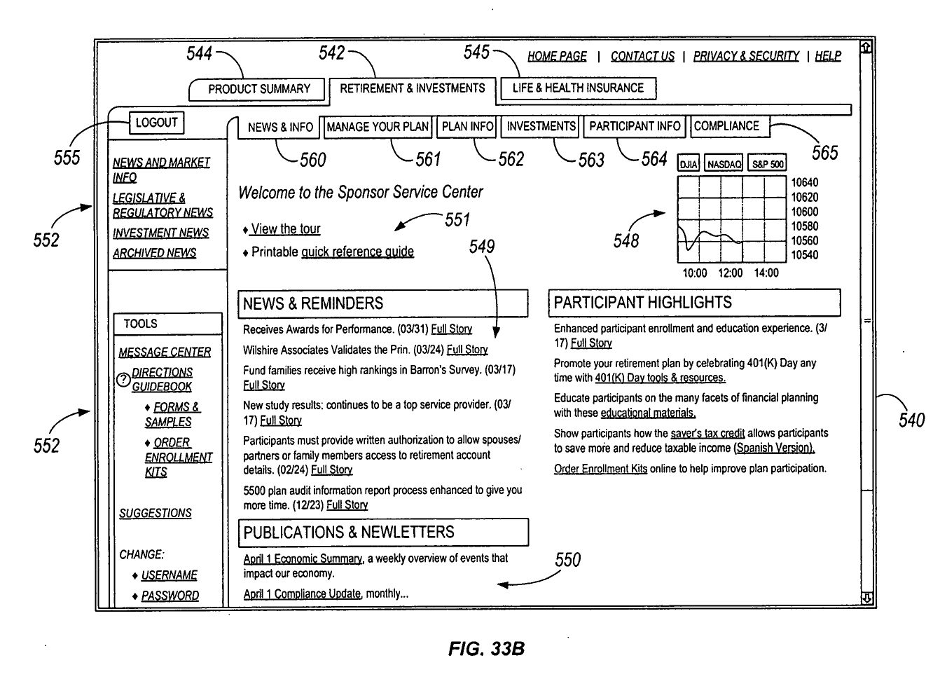

FIGS. 33A and 33B illustrate a main menu page 540 for a validated plan sponsor 16. In some embodiments, the main menu page 540 can be associated with particular benefit plan information, such as retirement plan information and/or savings plan information. As shown in FIGS. 33A and 33B, the main menu page 540 can be linked to a retirement and investments tab 542. In some embodiments, a parent main menu page can be associated with all benefit plan information. The main menu page 540 can include a product summary tab 544. Selecting the product summary tab can display a summary main menu page (not shown). The summary main menu page can display information regarding various types of benefit plans provided by the plan sponsor 16, the plan provider 14, other plan sponsors, and/or other plan providers (if applicable). In some embodiments, the main menu page 540 can also include a life and health insurance tab 545. Selecting the life and health insurance tab 545 can display a life and health insurance main menu page (not shown). The life and health insurance main menu page can display information regarding various types of medical-related benefit plans provided by the plan sponsor 16, the plan provider 14, and/or other plan sponsors or plan providers (if applicable).

In some embodiments, the main menu page 540 can include an important information box 547. As shown in FIGS. 33A and 33B, the main menu page 540 can include a current market indicator 548, a news and remainder box 549, and a participant highlights box 550. In some embodiments, the main menu page 540 can include one or more help links 551. Selecting on a help link 551 can display a manual, a reference guide, a tour, etc., which can provide instructions to the plan sponsor 16 on how to use the benefit data management system 500. The main menu page 540 can include one or more ancillary links 552. Selecting an ancillary link 552 can display additional information, such as news and market information, legislative and regulatory news, investment news, archived news, a message center, a directions guidebook, forms, samples, enrollment kit order forms, suggestions, username and password setup pages, security management pages, application download pages, etc.

The main menu page 540 can include a logout button 555. A user can select the logout button 555 in order to end their validated access to the benefit data management system 500. In some embodiments, selecting the logout button 555 can display the login page 510.

As shown in FIGS. 33A and 33B, the main menu page 540 can include one or more sub tabs. For example, the main menu page 540 can include a news and information sub tab 560, a manage your plan sub tab 561, a plan information sub tab 562, an investment sub tab 563, a participant information sub tab 564, and a compliance sub tab 565.

The benefit data management system 500 provides participant maintenance that allows a plan sponsor 16 to manage participant information. The benefit data management system 500 can allow plan sponsors 16 to add participants to a plan, import new participant information (e.g., in a particular file format, such as a comma separated or Lotus® fixed file), change existing participant information, perform activities associated with participant rehires, change investment direction, activate participants, report participant addresses, and/or perform benefit event notification.

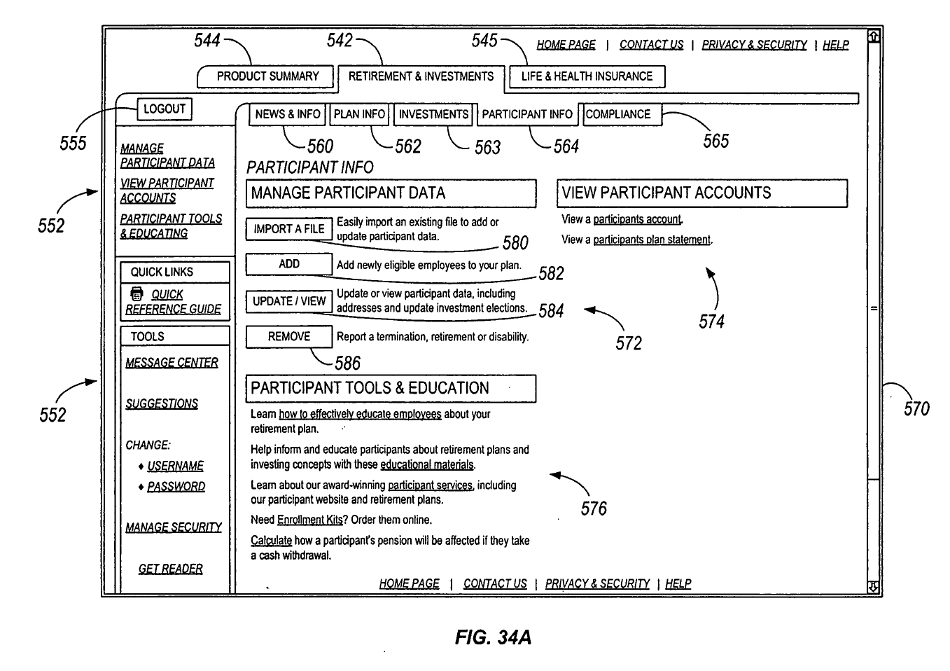

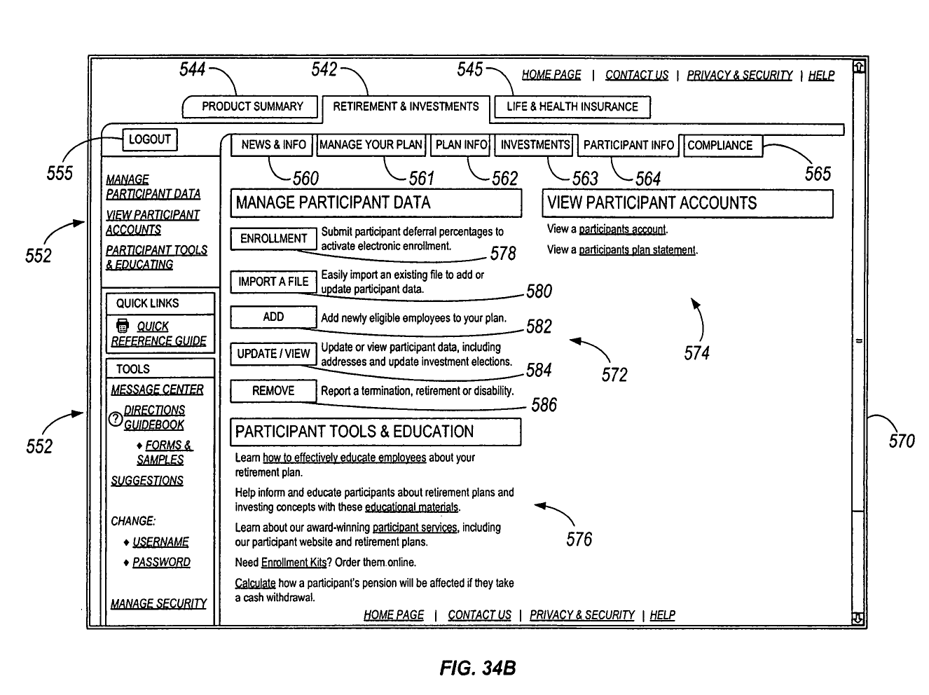

In some embodiments, to perform participant maintenance, a plan sponsor 16 can select the participant information sub tab 564 in order to view a participant information page. FIGS. 34A and 34B illustrate a participant information page 570 according to one embodiment of the invention. The participant information page 570 can include the product summary tab 544, the retirement and investments tab 542, the life and health insurance tab 545, one or more ancillary links 552, and the logout button 555. In some embodiments, the participant information page 570 can include the news and information sub tab 560, the manage your plan sub tab 561, the plan information sub tab 562, the investment sub tab 563, the participant information sub tab 564, and/or the compliance sub tab 565.

As shown in FIGS. 34A and 34B, the participant information page 570 can include a manage participant data box 572, a view participant account box 574, and a participant tools and education box 576. The manage participant data box 572 can include an enrollment button 578, an import a file button 580, an add button 582, an update/view button 584, and/or a remove button 586.

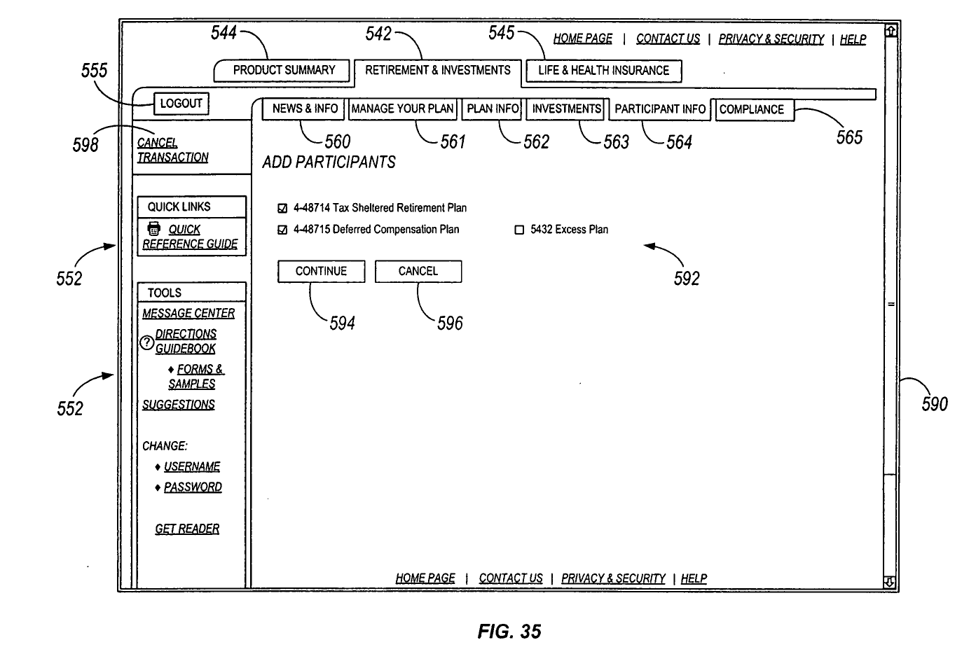

Selecting the add button 582 can display a first add participant page 590. FIG. 35 illustrates a first add participant page 590 according to one embodiment of the invention. As shown in FIG. 35, the first add participant page 590 can include the product summary tab 544, the retirement and investments tab 542, the life and health insurance tab 545, one or more ancillary links 552, the logout button 555, the news and information sub tab 560, the manage your plan sub tab 561, the plan information sub tab 562, the investment sub tab 563, the participant information sub tab 564, and the compliance sub tab 565.

The first add participant page 590 can display a list of plans or products 592 (e.g., retirement plans, medical plans, non-medical plans, etc.) that the plan sponsor 16 is authorized to provide. As shown in FIG. 35, the plan sponsor 16 can select each plan or product that they would like to offer or provide to a participant 12.

After the plan sponsor 16 selects zero or more offered plans or products, the plan sponsor 16 can select a continue button 594. The plan sponsor 16 can also select a cancel button 596 in order to cancel the addition of a participant. As shown in FIG. 35, the add participant page 590 can include a cancel transaction link 598. Selecting the cancel transaction link 598 can cancel the addition of a participant.

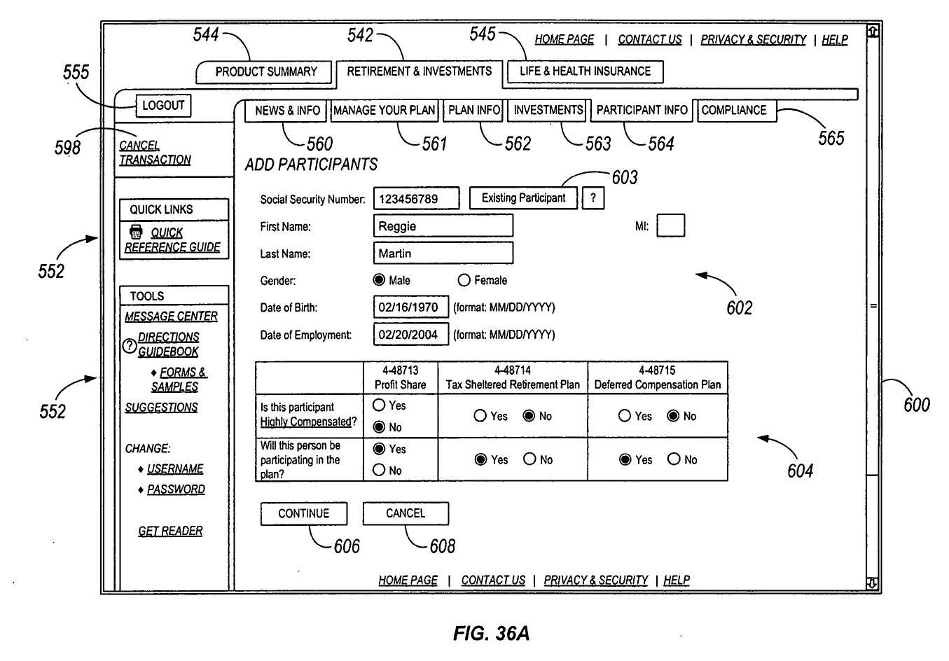

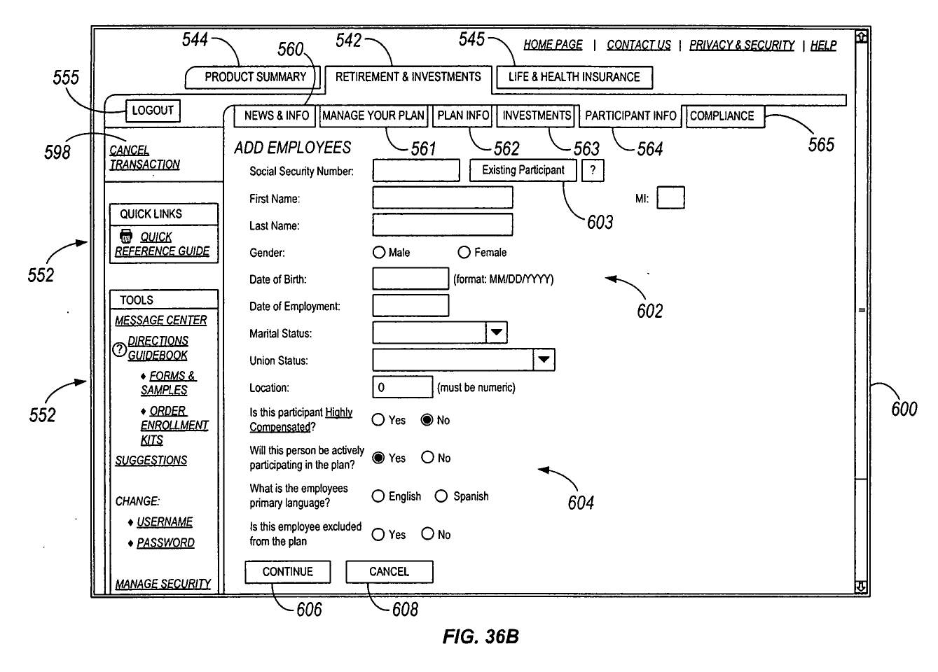

After selecting the continue button 584 on the add participant page 580, the benefit data management system 500 can display a second add participant page. FIGS. 36A and 36B illustrate second add participant pages 600 according to one embodiment of the invention. The second add participant page 600 can include the product summary tab 544, the retirement and investments tab 542, the life and health insurance tab 545, one or more ancillary links 552, the logout button 555, the cancel transaction link 598, the news and information sub tab 560, the manage your plan sub tab 561, the plan information sub tab 562, the investments sub tab 563, the participant information sub tab 564, and the compliance sub tab 565. As shown in FIGS. 36A and 36B, the second add participant page 600 can include one or more participant information entry mechanisms 602 that a plan sponsor 16 can use to enter participant data. The entry mechanisms 602 can include entry mechanisms for entering a social security number, a first name, a middle initial, a last name, a gender, a date of birth, a date of employment, a marital status, a union status, and a location of a participant 12. The entry mechanisms 602 can also include an entry mechanism for entering a beneficiary for a participant 12. In some embodiments, the entry mechanisms 602 can include multiple entry mechanisms for entering a beneficiary for each plan or product in which a participant 12 participates. As shown in FIGS. 34A and 34B, the plan sponsor 16 can select on an existing participant button 603 in order to bring up participant information that may be already stored or managed by the benefit data management system 500.

In some embodiments, the benefit data management system 500 can provide “smart-edits” in order to help clients verify accuracy of information and check information against applicable benefit program guidelines in order to assist with compliance (for example, checking contribution amounts against plan provisions and regulatory limits and/or verifying participant address information).

The second add participant page 600 can also include one or more additional selectors 604 for setting additional information of a participant 12, such as whether a participant 12 is considered highly compensated, whether a participant 12 will participate in a particular plan or product, a primary language of the participant 12, and whether the participant 12 is excluded from a particular plan or product. As shown in FIG. 36A, the plan sponsor 16 can set whether a participant 12 is considered highly compensated and whether a participant will participate in a particular plan for each plan or product offered by the plan sponsor 16. As described with respect to FIG. 35, the plan sponsor can select the plans or products to be offered to a participant 12.

In some embodiments, the additional selectors 604 can default to a predetermined value. For example, the primary language of the participant 12 can default to “English” and the indication as to whether the participant 12 is excluded from a particular plan can default to “No.”

Once the plan sponsor 16 has provided participant information as requested on the second add participant page 600, the plan sponsor 16 can select a continue button 606. The plan sponsor 16 can also select a cancel button 608 or the cancel transaction link 598 in order to cancel the addition of a participant 12.

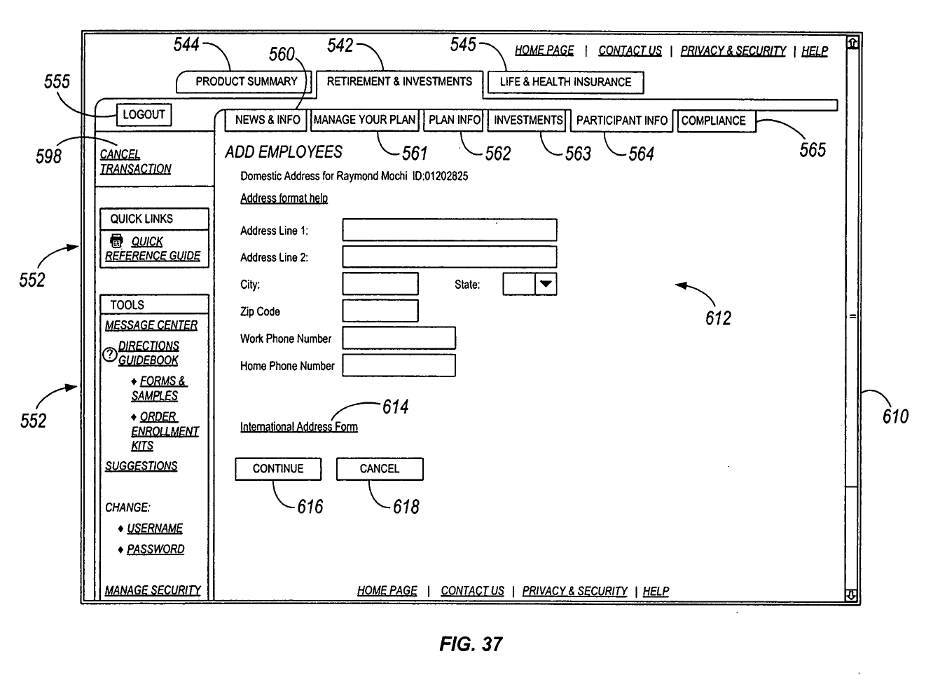

After selecting the continue button 606 on the second add participant page 600, an add participant address page 610 can be displayed, as shown in FIG. 37. The add participant address page 610 can include one or more entry mechanisms 612 that the plan sponsor 16 can use to enter a home address of a participant 12. In some embodiments, if a participant 12 has an international address, the plan sponsor 16 can select an international address form link 614 in order to display a form or entry screen for entering an international address.

After the plan sponsor 16 enters a participant home address, the plan sponsor 16 can select a continue button 616 on the add participant address page 610. The plan sponsor 16 can also select a cancel button 618 or the cancel transaction link 598 in order to cancel the addition of a participant 12.

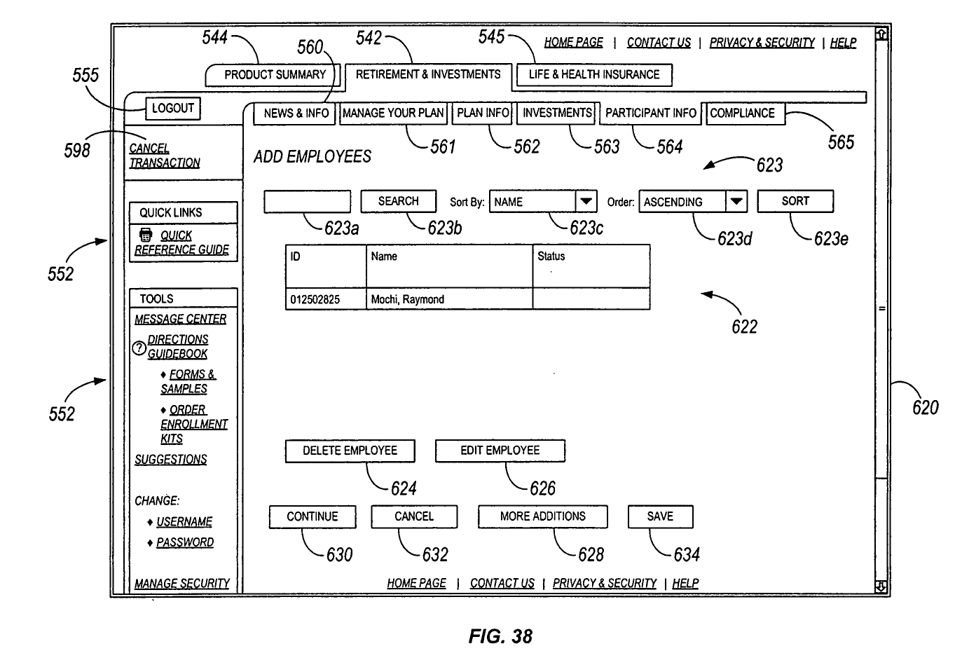

After selecting the continue button 616 on the add participant address page 610 (or a similar page for entering an international participant address), a summary page can be displayed. FIG. 38 illustrates an add participant summary page 620 according to one embodiment of the invention. The add participant summary page 620 can display a list of added participants 622. In some embodiments, the list of added participants 622 can include an identifier, name, and status for each participant 12 added by the plan sponsor 16. The add participant summary page 620 can include one or more sort/search mechanisms 623. As shown in FIG. 38, the sort/search mechanisms 623 can include a search keyword entry mechanism 623a, a search button 623b, a sort by selector 623c, an order by selector 623d, and a sort button 623e. The plan sponsor 16 can enter a search keyword using the search keyword entry mechanism 623a and can select the search button 623b in order to search the list of added participants 622 for the entered keyword. The plan sponsor 16 can also enter sorting criteria using the sort by selector 623c and the order by selector 623d. The plan sponsor 16 can then select the sort button 623e in order to sort the list of added participants 622 according to the sorting criteria.

The plan sponsor 16 can delete an added participant 12 by selecting (e.g., highlighting) one or more participants 12 listed in the list of added participants 622 and selecting a delete participant button 624. The plan sponsor 16 can edit an added participant 12 by selecting (e.g., highlighting) a participant 12 listed in the list of added participants 622 and selecting an edit participant button 626. Selecting the edit participant button 626 can display the first add participant page 590, the second participant page 600, and/or the add participant address page 610 with the previously-entered participant information.

If the plan sponsor 16 needs to enter participant information for another participant 12, the plan sponsor 16 can return to the first add participant page 590 by selecting a more additions button 628 on the add participant summary page 620. Each time the plan sponsor 16 enters additional participant data and returns to the add participant summary page 620, the add participant summary page 620 lists all participant information entered.

Once the plan sponsor 16 enters participant information, the plan sponsor 16 can select a continue button 630 on the add participant summary page 620 in order to submit the entered participant information. The plan sponsor can also select a cancel button 632 in order to cancel the submission of the participant information. In some embodiments, the plan sponsor can select a save button 634 on the add participant summary page 620. Selecting the save button 634 can save the entered participant information without submitting the information. The plan sponsor 16 can retrieve the saved participant information at a later time and can add additional participant information and/or modify the entered participant information.

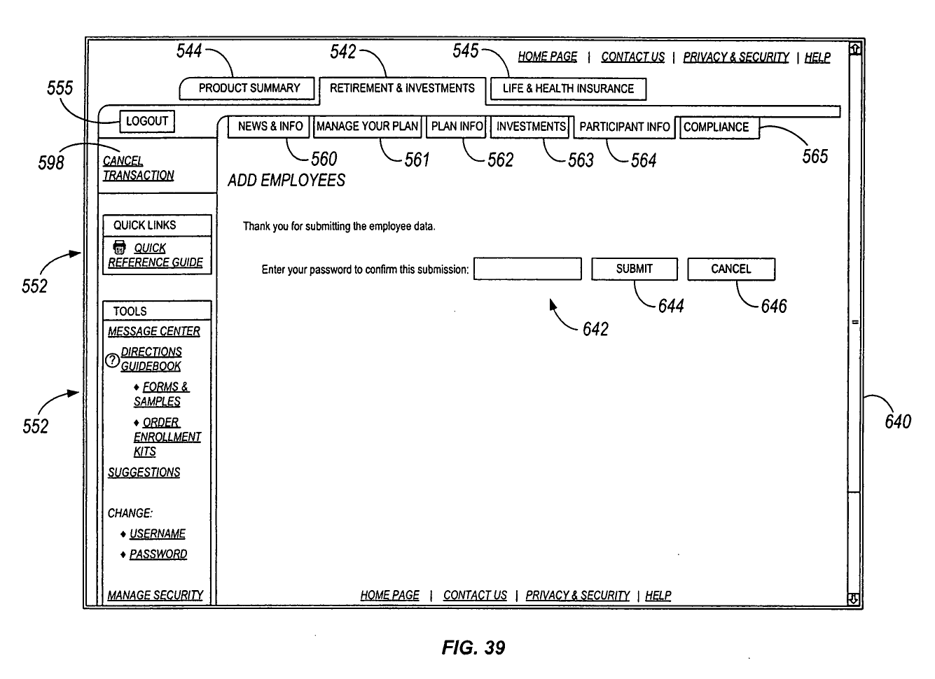

After selecting the continue button 630 on the add participant summary page 620, the benefit data management system 500 can display an add participant confirmation page 640, as shown in FIG. 39. The add participant confirmation page 640 can include a confirmation code or security code entry mechanism 642 that prompts the plan sponsor 16 to enter a confirmation or security code, such as a personal identification number (“PIN”) and/or a password. After entering the confirmation code, the plan sponsor 16 can select a submit button 644 on the add participant confirmation page 640. The plan sponsor 16 can also select a cancel button 646 or the cancel transaction link 598 in order to cancel submission of the entered participant information.

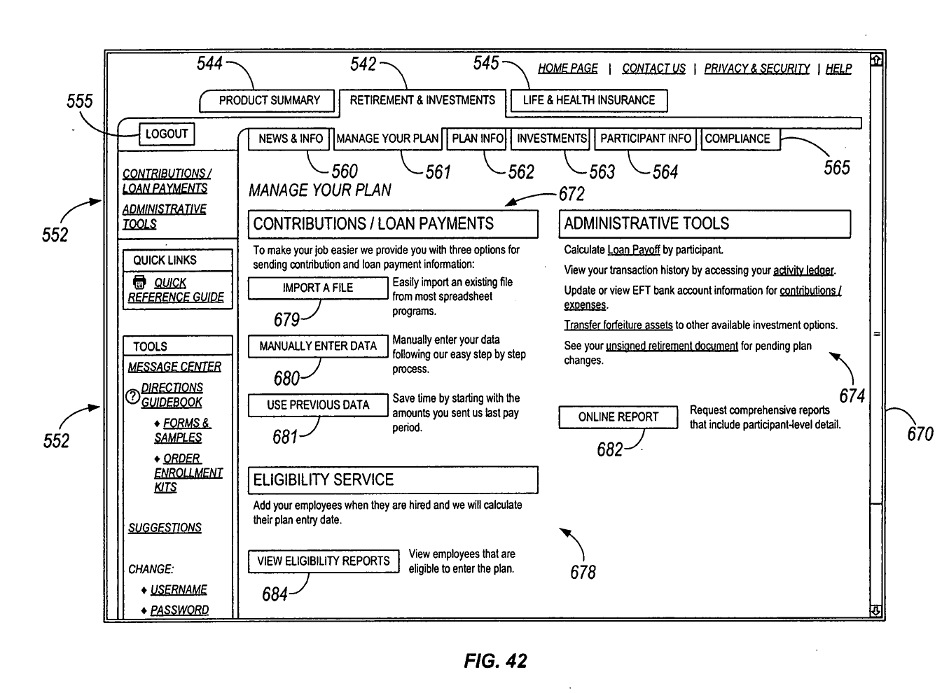

After selecting the submit button 644 on the add participant confirmation page 640, the benefit data management system 500 can verify the security code and can build a record for the participant. Each record can be assigned an identification number. In some embodiments, the identification number can include a plan sponsor number (e.g., a plan identifier) and a product identifier. If the plan sponsor 16 selected multiple plans or products to be offered to the added participant 12, the benefit data management system 500 can build a record for the participant 12 for each plan or product selected. The benefit data management system 500 can calculate a plan entry date for each plan a participant 12 participates in. The plan entry date can be based on the entered participant information and specific eligibility requirements or provisions of a particular benefit plan. The plan entry date can be used to generate eligibility report, as described with respect to FIGS. 42-44.

In some embodiments, a participant 12 can add additional participant information using page or forms similar to the pages used by a plan sponsor 16.

In some embodiments, participant information provided by a plan sponsor 16 and/or a participant 12 can be entered once and can be applied for multiple benefit plans. For example, if a participant is enrolling in a retirement plan, a health savings account plan, and a life insurance plan, the plan sponsor 16 and/or the participant can input participant information using pages displayed by the benefit data management system 500 once instead of three times. In some embodiments, participants 12 can provide a single signed contract or enrollment form to a plan sponsor 16 to authorize enrollment in multiple benefit plans. Updated information can also be applied across benefit plans as applicable.

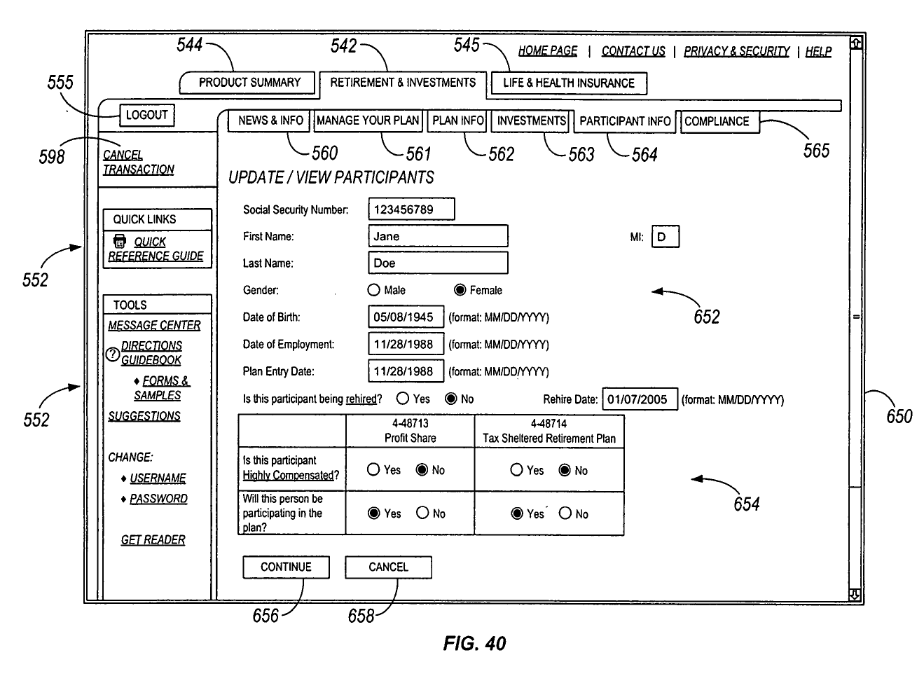

As described with respect to FIGS. 34A and 34B, the participant information page 570 can include the update/view button 584. If the plan sponsor 16 selects the update/view button 584, the benefit data management system 500 can display an update/view participant page 650, as shown in FIG. 40. The update/view participant page 650 can include the product summary tab 544, the retirements and investments tab 542, the life and health insurance tab 545, the logout button 555, the cancel transaction link 598, one or more ancillary links 552, the news and information sub tab 560, the manage your plan sub tab 561, the plan information sub tab 562, the investments sub tab 563, the participant information sub tab 564, and the compliance sub tab 565.

As shown in FIG. 40, the update/view participant page 650 can include one or more entry mechanisms 652 similar to those included in the second add participant page 600. The entry mechanisms 652 can display participant information previously entered and can allow the plan sponsor 16 to update the participant information. For example, the update/view participant page 650 can include entry mechanisms 652 for viewing and/or updating a social security number, a first name, a middle initial, a last name, a gender, a date of birth, a date of employment, and/or a plan entry date.

As shown in FIG. 40, the update/view participant page 650 can also include one or more additional selectors 654. The plan sponsor 16 can use the additional selectors 654 to view and/or update additional information about a participant 12. For example, the plan sponsor 16 can use the additional selectors 654 to view and/or update whether a participant 12 is being rehired and a rehire date if applicable, whether a participant 12 is considered highly compensated, and/or whether a participant will be participating in a particular plan or product offered by the plan sponsor 16.

After the plan sponsor 16 has view and/or updated the participant information on the update/view participant page 650, the plan sponsor 16 can select a continue button 656. In some embodiments, if the plan sponsor 16 updated the participant information, selecting the continue button 656 can cause the benefit plan management system 500 to display the add participant confirmation page 640, as described with respect to FIG. 39. The plan sponsor 16 can also select a cancel button 658 in order to cancel viewing and/or updating the participant information.

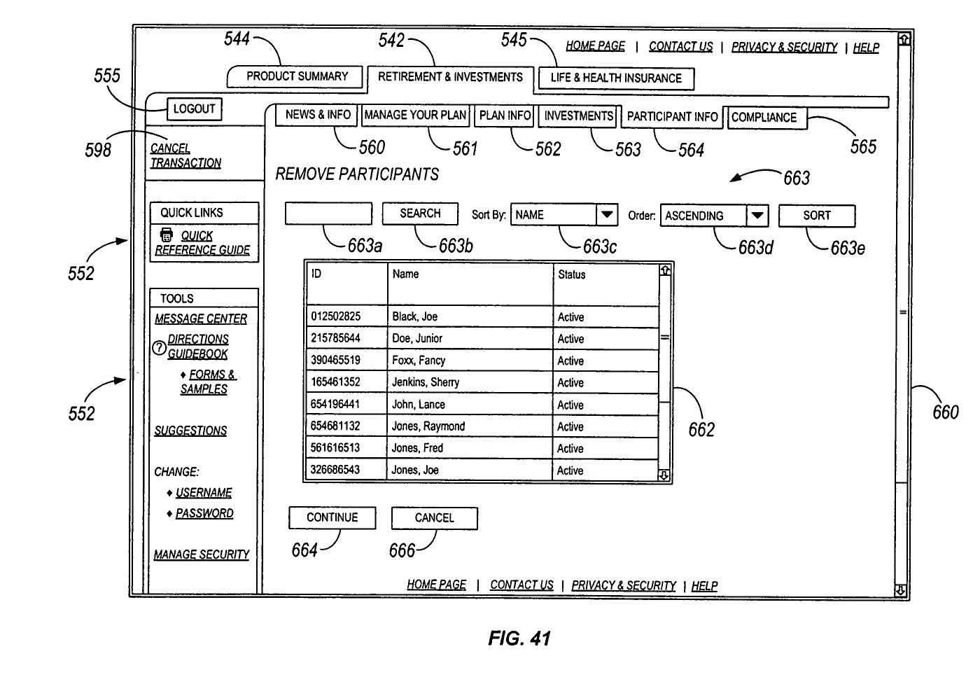

As described with respect to FIGS. 34A and 34B, the participant information page 570 can include the remove button 586. If the plan sponsor 16 selects the remove button 586, the benefit data management system 500 can display a remove participant page 660, as shown in FIG. 41. The remove participant page 660 can include the product summary tab 544, the retirements and investments tab 542, the life and health insurance tab 545, the logout button 555, the cancel transaction link 598, one or more ancillary links 552, the news and information sub tab 560, the manage your plan sub tab 561, the plan information sub tab 562, the investments sub tab 563, the participant information sub tab 564, and the compliance sub tab 565.

As shown in FIG. 41, the remove participant page 660 can include a list of participants 662. The list of participants 662 can list participants previously entered by the plan sponsor 16. In some embodiments, the list of participants 662 includes an identifier, name, and status of zero or more participants 12. As shown in FIG. 41, the remove participant page 660 can include one or more sort/search mechanisms 663. The sort/search mechanisms 663 can include a search keyword entry mechanism 663a, a search button 663b, a sort by selector 663c, an order by selector 663d, and a sort button 663e. The plan sponsor 16 can enter a search keyword using the search keyword entry mechanism 663a and can select the search button 663b in order to search the list of participants 662 for the entered keyword. The plan sponsor 16 can also enter sorting criteria using the sort by selector 663c and the order by selector 663d. The plan sponsor 16 can then select the sort button 663e in order to sort the list of participants 662 according to the sorting criteria.

To delete or remove a participant, the plan sponsor 16 can select one or more participants listed in the list of participants 662 (e.g., by highlighting participants) and can select a continue button 664 on the remove participant page 660. The plan sponsor 16 can also select a cancel button 666 or the cancel transaction link 598 in order to cancel the removing of a participant 12.

As described with respect to FIG. 9, if a plan sponsor 16 is adding information regarding multiple employees, a plan sponsor 16 can import a file including the participant information. To import a file, the plan sponsor 16 can select the import a file button 580 on the participant information screen 570 in order to import a file with a particular format (e.g., a comma separated or Lotus fixed file) in order to add and/or update participant information.

In some embodiments, the benefit data management system 500 can facilitate participant eligibility determination for clients. The benefit data management system 500 can obtain a range of participant data/attributes in order to facilitate eligibility determination, as well as other potential services, such as expanded vesting services (including “real-time” vesting updates), determination of eligibility for plan provider contributions, reduction of or elimination of annual data collection process, and customized participant communication. Examples of participant data/attributes used to facilitate eligibility determination can include current and past deferral amounts, salary, hours worked, benefit event and rehire information, etc.

The benefit data management system 500 can collect and store participant information for determining eligibility and can calculate or determine eligibility information. Eligibility information can include information regarding degrees of eligibility for a benefit plan and/or benefit plan options for a particular participant. For example, the benefit data management system 500 can determine whether a participant is eligible for a plan at a plan entry date, whether a participant is close to meeting eligibility requirements but has not met them yet, whether a participant is eligible for a particular benefit plan option (e.g., matching contribution on a retirement plan), an eligibility status of a participant (e.g., how many years of service are needed before a participant becomes eligible for a particular benefit plan), etc. In some embodiments, the benefit data management system 500 can work with a third-party system, such as a payroll provider to obtain participant information (e.g., name, hire date, birth date, etc.) and/or eligibility requirements. Eligibility can be determined based on one or more eligibility requirements, such as on actual hours and elapsed time calculations. In some embodiments, the benefit data management system 500 can implement a plan entry date projection calculation and a scheduling routine. The benefit data management system can offer the ability to handle dual (or multiple) eligibility and can provide the capability to exclude specified participants from the calculation.

To obtain eligibility information, a plan sponsor 16 can obtain an eligibility report. In some embodiments, a plan sponsor 16 can obtain an eligibility report at predetermined times (e.g., a predetermined amount of days prior to an eligibility entry period) or at the request of the plan sponsor 16. For example, an eligibility report can be generated 65 days prior to an eligibility entry period of a particular benefit plan. In some embodiments, timing of the eligibility report can be based on specific provisions or settings or a particular plan.

In some embodiments, an eligibility report can identify various eligibility degrees or categories. For example, an eligibility report can identify zero or more participants whose calculated plan entry date falls in the next entry period, zero or more participants who are close to meeting eligibility requirements but have not meet them yet, and/or an eligibility status (e.g., eligible or not eligible and/or requirements yet to be met) of zero or more participants.

In some embodiments, to generate an eligibility report a plan sponsor 16 can select the manage your plan sub tab 561. Selecting the manage your plan sub tab 561 can cause the benefit data management system 500 to display a manage your plan page. FIG. 42 illustrates a manage your plan page 670 according to one embodiment of the invention. The manage your plan page 670 can include the product summary tab 544, the retirements and investments tab 542, the life and health insurance tab 545, the logout button 555, one or more ancillary links 552, the news and information sub tab 560, the manage your plan sub tab 561, the plan information sub tab 562, the investments sub tab 563, the participant information sub tab 564, and the compliance sub tab 565.

As shown in FIG. 42, the manage your plan page 670 can include a contributions/loan payments box 672, an administrative tools box 674, and a eligibility service box 678. The contributions/loan payments box 672 can include an import a file button 679, a manually enter data button 680, and a use previous data button 681. As described with respect to FIGS. 6-9, the plan sponsor 16 can use the import a file button 679, the manually enter data button 680, and/or the use previous data button 681 to provide contribution and loan payment information.

The administrative tools box 674 can include an online report button 682 to request report, such as reports including participant-level information. In some embodiments, a plan sponsor 16 can select the online report button 682 to view a summary of benefit plan information as described with respect to FIGS. 46, 47A, 47B, and 48.

The benefit data management system 500 can also provide client ad-hoc reporting capabilities via client request, facilitate fiduciary program services (e.g., including on-line tools, checklists, etc.), current contribution limit monitoring services to more proactively monitor participant contributions and alert plan sponsors 16 and/or participants 12 when deferrals limits are met or are projected to be met, etc., provide expanded loan monitoring and reporting, provide enhancements to current location recordkeeping capabilities, and provide the ability for a plan sponsor to report beneficiaries for a participant.

The eligibility service box 678 can include a view eligibility reports button 684. The plan sponsor 16 can select the view eligibility reports button 684 in order to view participants that are or will be eligible for a particular plan or product.

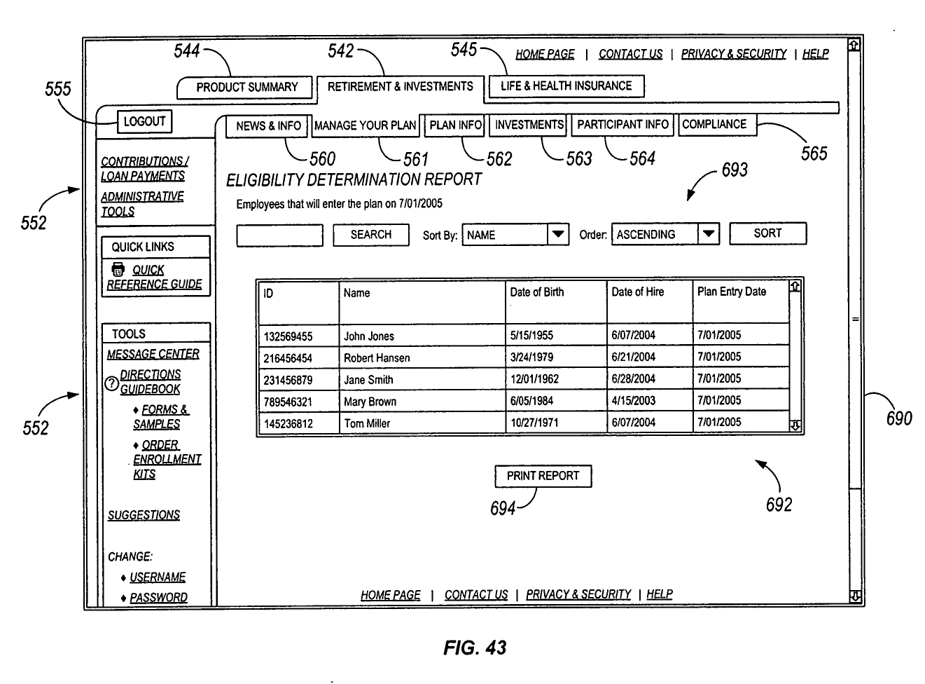

In some embodiments, after selecting the view eligibility report button 684, the benefit data management system can display an eligibility determination report page 690, as shown in FIG. 43. The eligibility determination report page 690 can include an eligibility report 692. The eligibility report 692 can list participants eligible to enter a particular plan or product within a particular entry period. For example, the eligibility report 692 can list identification, name, date of birth, date of hire, and/or plan entry date for eligible participants 12.

In some embodiments, a plan or product can have a monthly entry period. The eligibility report 692, as shown in FIG. 43, includes an eligibility report for a plan having eligibility requirements of a year of service and an age of 21. Eligibility reports can be generated prior to an upcoming entry period. For example, the eligibility report 692 was generated on May 2, 2005, sixty-five days prior to an entry period starting Jul. 1, 2005.

The eligibility determination report page 690 can include one or more sort/search mechanisms 693. As shown in FIG. 43, the sort/search mechanisms 693 can include a search keyword entry mechanism 693a, a search button 693b, a sort by selector 693c, an order by selector 693d, and a sort button 693e. The plan sponsor 16 can enter a search keyword using the search keyword entry mechanism 693a and can select the search button 623b in order to search the eligibility report 692 for the entered keyword. The plan sponsor 16 can also enter sorting criteria using the sort by selector 693c and the order by selector 693d. The plan sponsor 16 can then select the sort button 693e in order to eligibility list 692 according to the sorting criteria.

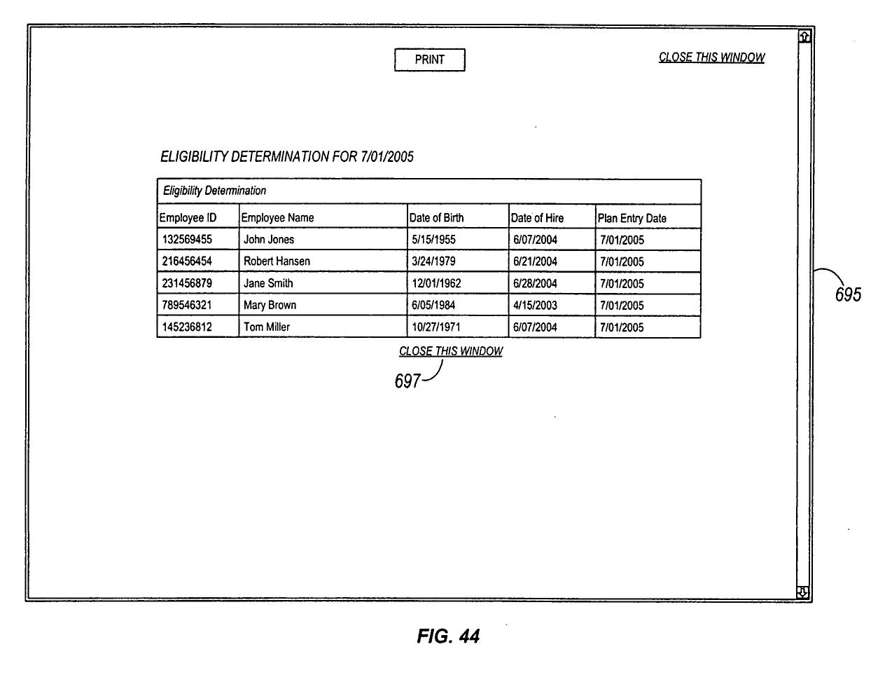

As shown in FIG. 43, the eligibility report 692 can be printed. To obtain a printable version of the eligibility report, a plan sponsor 16 can select on a print report button 694 on the eligibility determination report page 690. FIG. 44 illustrates an example of a printable version of the eligibility report 695. The plan sponsor can select a close this window link 697 on the printable version of the eligibility report 695 in order to close the printable version of the eligibility report 695.

After the plan sponsor 16 generates an eligibility report, the plan sponsor 16 can prepare welcome correspondence (e.g., a letter or a postcard) and/or an enrollment kit for eligible participants. In some embodiments, the benefit data management system 500 can automate the welcome correspondence and/or enrollment kit creation and/or distribution process.

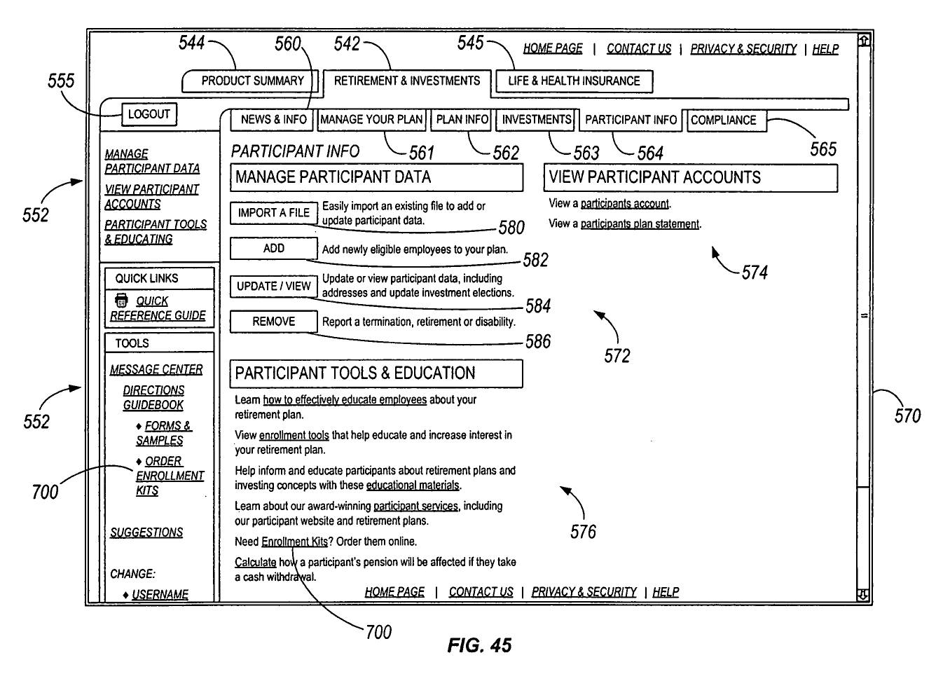

The benefit data enrollment system 500 can allow a plan sponsor 16 to order welcome correspondence and/or enrollment kits online. As shown in FIG. 45, the participant information page 570 can include one or more enrollment kit links 700. The benefit data management system 500 can generate and/or provide welcome correspondence and/or enrollment kits to the plan sponsor 16 and/or directly to the participants 16. The enrollment kits can be provided electronically, such as in an email message or as a file. The enrollment kits can also be mailed using a postal service, such as the United States Postal Service.

In some embodiments, the welcome correspondence can include a postcard. The postcard can be customized based on the participant receiving the postcard, the degree of eligibility being reported to the participant, the benefit plan or benefit plan options that the participant is eligible for, the plan sponsor associated with a benefit plan or benefit plan options that the participant is eligible for, etc. In some embodiments, the benefit data management system 500 can send follow-up correspondence, such as a follow-up postcard. The follow-up postcard can indicate a successful enrollment or successful declination of enrollment or a reminder of one or more benefit plan or benefit plan options that a participant is eligible for. For example, the benefit data management system 500 can send a follow-up post to participants that have not enrolled or declined enrollment for an eligible benefit plan and/or benefit plan options within 30 days of their original eligibility or entry date.

As described above, the benefit data management system 500 can provide an eligibility report to the plan sponsor 16 in order to notify them of newly eligible participants. In some embodiments, the benefit data management system 500 can send confirmation to the plan sponsor 16 after a participant 12 enrolls and/or can provide a report to the plan sponsor 16 in order to notify them of an eligible participant 12 that has not enrolled. A report indicating that an eligible participant 12 has not enrolled in a particular plan can be generated if an eligible participant 12 does not enroll within 30 days from being notified of eligibility.

As described with respect to FIGS. 10 and 11, the benefit data management system 500 can provide compliance data functionality, such as salary reporting, salary importing (e.g., in a particular file format, such as a comma separated or Lotus fixed file), and/or compliance data reporting. Selecting the compliance sub tab 565 can display one or more pages for view and/or providing compliance information.

In some embodiments, the benefit data management system 500 provides deferral and match calculation services. For example, eligible clients can have the ability to submit current compensation using a manual data enter option and an import option. Compensation can be used for the deferral and/or match calculation only and, therefore, do not post to participant records. Clients can see a reminder on a page or form each time they use the contribution calculation option.

The deferral and match calculation services can also allow eligible clients to calculate a deferral contribution and a matching contribution. The deferral calculation can be based on a participant deferral percent and/or dollar amount. The match calculation can use a current match formula and the deferral percent or dollar amount. If a client is not using electronic enrollment, the matching contribution can be performed using a calculated deferral percent based on the deferral amount entered by the client.

In some embodiments, the deferral and match calculations services can also allow eligible clients to view their match formula on one or more contribution data entry pages, print reports, and view reports, such as contribution detail report and summary reports.

In some embodiments, the benefit data management system 500 can provide location recordkeeping services. For example, the benefit data management system 500 can provide location recordkeeping for clients whose locations have less than 10,000 people. For clients that meet this requirement, contribution and participant data can be submitted to the benefit data management system by location, which can require that data be submitted for one location at a time.

In some embodiments, clients wanting to add location recordkeeping or parts of the service must have a client relationship that is not at risk, be considered profitable by the institutional market segment, and have reports sorted by location.

In some embodiments, there can be restrictions and constraints on what location recordkeeping can perform. For example, contract or location level reports can be limited to one request per day; contributions submitted to the benefit data management system 500 can be required to be submitted separately by location; EFTs, expense data, and compliance data can be available, but not by location; and location sorting for reports can be required to be coded to sort by location.

As described above, the benefit data management system 500 can provide a single location for receiving communications from a plan sponsor 16 and/or a participant 12, as well as handling administrative functions, such as contributions and data reporting, and viewing plan sponsor 16 and/or participant 12 information and accounts. The benefit data management system 500 summarizes information for benefit plans offered by the plan provider 14 and/or other plan providers through one or more plan sponsors 16 and provides access from one location to view and provide benefit plan information.

As described with respect to FIG. 31A, the benefit data management system 500 can provide benefit plan information management for products and plans outside of employer-sponsored retirement plans, including non-medical plans and products, medical plans and products, and individual financial products offered, such as IRAs, mutual funds, 529 accounts, life and health insurance, HSAs, disability, employee stock purchase plan, stock options, etc. In some embodiments, the benefit data management system 500 can include applications for health benefits administration, workman's compensation, and consolidated omnibus budget reconciliation act of 1985 (“COBRA”) and/or health insurance portability and accountability act of 1996 (“HIPPA”) processing. From a human resources outsourcing (“HRO”) perspective, the benefit data management system 500 can be used to provide payroll services and employee administration. The benefit data management system 500 can also provide consolidated client and participant reports via the appropriate media.

The benefit data management system 500 can also collect information regarding benefits held by plan providers other than the plan provider managing the benefit data management system 500 in order to facilitate comprehensive benefit reporting (via appropriate media) to clients and participants. In some embodiments, the benefit data management system 500 can generate a benefit data summary that includes a summary of all benefit plan information managed by the benefit data management system 500. This could include any type of benefit plan or product, such as, but not limited to, medical, dental, and vision coverage insurance offerings, disability, Social Security and Medicare, regular compensation, vacation and holiday compensation, and other company perks.

The benefit data management system 500 can provide benefit data management that integrates and coordinates information received from various sources, such as a plan sponsor 16 and/or a participant 12 and can provide updates to a plan sponsor 16 and/or a participant 12. In some embodiments, the benefit data management system 500 can provide benefit data management that integrates and coordinates information provided by third party, such as a payroll provider. The benefit data management system 500 can allow the third party to work directly with the plan provider 14 on behalf of a plan sponsor 16 and/or a participant 12 to provide information. In some embodiments, a third-party system, such as a payroll provider can play the role of a plan sponsor and/or a plan provider and can provide benefit plans (e.g., savings plans) directly to participants (e.g., to employees rather than or in addition to benefit plans offered by an employer of the employees).

The benefit data management system 500 can provide a single location/source of information for the client for all benefit programs and a single location for client submission of data and contributions for the client for all benefit programs. The benefit data management system 500 can also provide sharing of single-source information among applicable benefit programs to ensure efficient and accurate operation and an ability to integrate to exchange data with other third parties, such as payroll providers, in order to service benefit plans.

The benefit data management system 500 can provide a contact information page that includes internal and/or external contacts for a contract specified by the user. The contact information page can help users get in contact with correct personnel, without having to hunt to find information and without having their phone calls or other correspondence re-routed.

By managing benefit plan information in a single system, the benefit management system 500 can cross-sell. In some embodiments, the benefit data management system can use business rules, pattern recognition or other statistical mechanism to determine other plans and/or products that a participant 12 and/or a plan sponsor 16 may be interested in. For example, the benefit management system 500 can suggest a way to attach additional savings arrangements to a core retirement savings account of a participant. For instance, if a participant has a $20,000 401(k) account balance, the benefit management system 500 can suggest considering additional savings arrangements as part of an overall program in order to create a $25,000 overall account balance for front-end data, back-end reporting, and overall pricing purposes. In another example, the benefit data management system 500 can suggest additional life insurance for a participant with a significant mortgage. By accessing benefit plan information for a participant 12, the benefit data management system 50 can cross-sell benefit plans and products and/or can offer bundled plan or product solution. In some embodiments, if a participant selects one or more additional plans or products to participate in, the benefit data management system 500 can base the price or settings of the additional plans or products based on the benefit plans that the participant 12 already participates in.

In some embodiments, the benefit management system 500 can provide a summary of benefit plan information. The summary of benefit plan information can include a comprehensive or consolidated view of benefit plan information, such as including information about multiple benefit plans and multiple types of benefit plans. The summary can be provided on a page or form provided to the client computer 404, such as over the Internet, or a statement provided in paper form. The benefit management system 500 can generate a summary of benefit plan information and can display the summary to a participant 12 and/or a plan sponsor 16. In some embodiments, a summary of benefit plan information can be formatted to substantially fit on a single page or form.

In some embodiments, a summary can include an indication of current benefit plan information and projected benefit plan information (e.g., projected Social Security benefits). The summary can include textual indications of benefit plan information and/or graphical indications of benefit plan information (e.g., graphs). In some embodiments, counselors provided by a plan provider 14 and/or a plan sponsor 16 can meet individually with participants 12 in order to match goals and objectives of plan sponsors 16 and/or participants with plans and/or products available. The counselors can use the summary to show participants a comprehensive view of current benefit plan information as well as projected benefit plan information. The summary can be updated at predetermined intervals and/or when a plan sponsor 16, plan provider 14, and/or participant 12 updates benefit plan information. In some embodiments, a summary available online is updated daily with current market information and other influential information. FIGS. 46, 47A, 47B, and 48 each illustrate a summary of benefit plan information 800 (a “total benefit statement” or a “total benefit view”) according to various embodiments of the invention. In some embodiments, FIG. 46 illustrates a summary of benefit plan information 800 provided electronically, such as over the Internet, to a plan sponsor 16 and/or a participant 12. As shown in FIG. 46, a plan sponsor 16 and/or participant 12 can print the summary of benefit plan information 800. In some embodiments, the summary of benefit plan information 800 provided electronically can include a print button 802 (e.g., a printer friendly format button). A plan sponsor 16 and/or participant 12 can select the print button 802 to print the summary of benefit plan information 800 provided electronically in order to obtain a paper or hard copy.

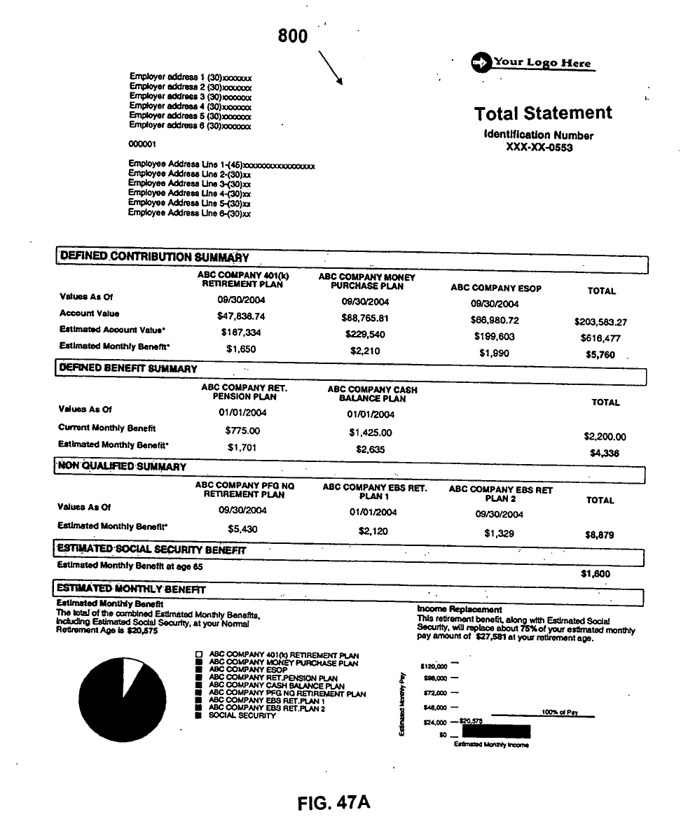

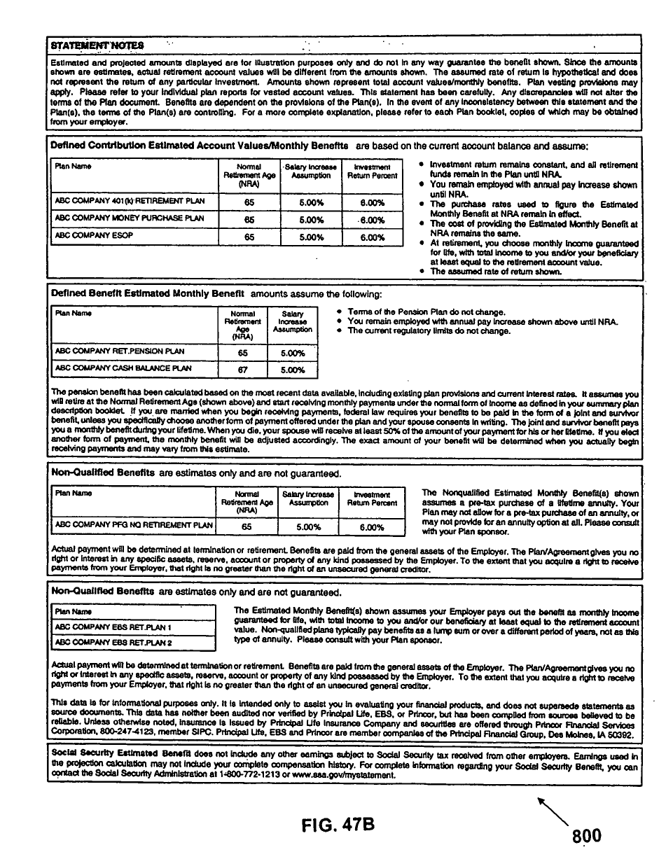

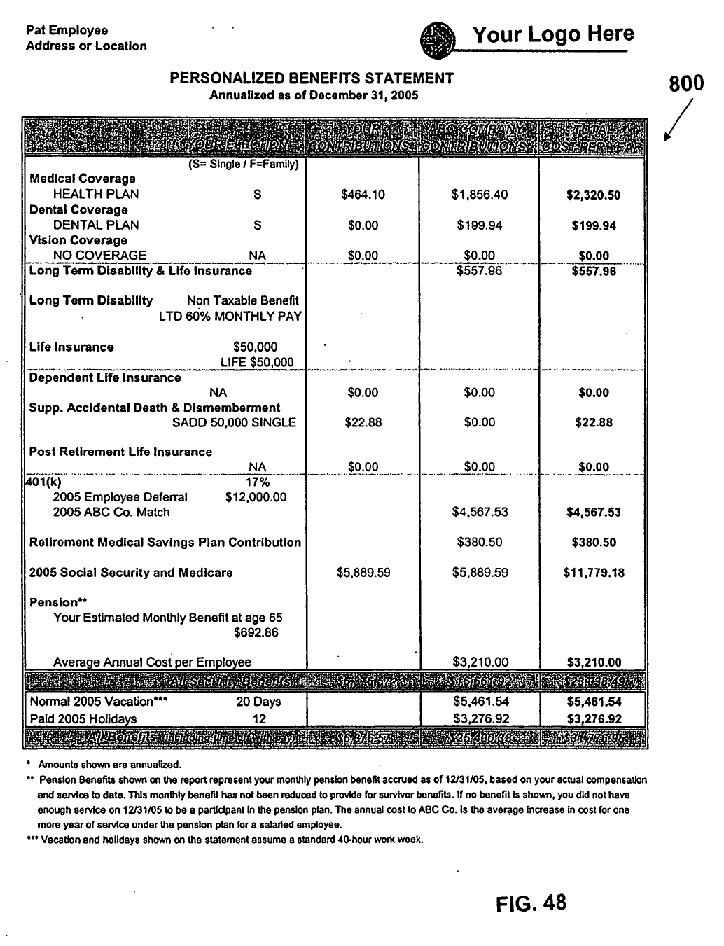

FIGS. 47A and 47B illustrate a summary of benefit plan information 800 provided in paper form, such as in a summary statement, to a plan sponsor 16 and/or a participant 12. FIG. 48 illustrates another summary of benefit plan information 800 that can be provided electronically, such as over the Internet, or in paper form, to a plan sponsor 16 and/or a participant 12.

As shown in FIGS. 46, 47A, 47B, and 48, a summary of benefit plan information 800 can include an estimated monthly benefit (which includes an estimate of Social Security benefits). In some embodiments, the estimated monthly benefit can indicate an estimated monthly benefit at retirement (e.g., at a predetermined age). The estimated monthly benefit can broken down into one or more sub-benefits, such as benefits from employee stock option plans, benefits from an excess plan, benefits from a pension plan, benefits from a salary reduction plan, benefits from a medical savings plan, benefits from Social Security and/or Medicare, etc. As shown in FIGS. 46, 47A, and 47B, the sub-benefits can be shown textually and/or graphically as a dollar amount of the estimated monthly benefit or a percentage of the estimated monthly benefit.

A summary of benefit plan information 800 can include an income replacement indication (see FIGS. 46, 47A, and 47B). The income replacement indicator can indicate (textually or graphically) an estimation of a percentage of an estimated monthly pay amount at a predetermined retirement age (e.g., 65).

As shown in FIG. 48, a summary of benefit plan information 800 can include one or more benefit plans or other financial services or products associated with a plan sponsor 16 and/or a participant 12. For example, a summary of benefit plan information 800 can include information associated with a medical plan, a dental plan, a vision plan, a long-term disability plan, a life insurance plan, a supplemental accidental death and dismemberment plan, a post retirement plan, a salary reduction plan (e.g., a 401(k) plan), a retirement medical savings plan, a Social Security plan, a Medicare plan, a pension plan, a holiday compensation plan, a vacation compensation plan, and/or other types of benefit plans. In some embodiments, a summary of benefit plan information 800 can indicate benefits associated with a particular benefit plan for a particular time period (e.g., a year). A summary of benefit plan information 800 can include information about benefit plan options and/or elections. For example, as shown in FIG. 48, the summary of benefit plan information 800 can indicate single or family plan elections, non-taxable benefits, percentages of monthly pay, insurance values, contribution values, etc.

In some embodiments, a summary of benefit plan information 800 can include costs associated with one or more benefit plans. As shown in FIG. 48, the summary of benefit plan information 800 can include one or more costs associated with a particular benefit plan. In some embodiments, costs can be divided between costs associated with a participant (e.g., an employee) and costs associated with a plan sponsor (e.g., an employer).

In some embodiments, a summary of benefit plan information 800 can include information associated with one or more benefit plans offered by the plan provider 14 and/or another provider (e.g., a financial services provider (a bank), a human resources provider, etc.). As described above with respect to FIG. 31, a provider (difference from the plan provider 14) can provide benefit plan information and/or other information that can be integrated and/or managed with the benefit data management system 500 and included on a summary of benefit plan information 800. In some embodiments, a plan sponsor 16 and/or a participant 12 can provide additional information (e.g., information unrelated to benefit plans offered by the plan provider 14) to the benefit data management system 500 that can be included in a summary of benefit plan information 800.

A summary of benefit plan information 800 can be customized to a particular plan sponsor 16 and/or participant 12. For example, text and graphics (e.g., logos) can be included in a summary of benefit plan information 800 that are customized to a plan sponsor 16 and/or participant 12. Benefit information included in a summary of benefit plan information 800 can be customized. For example, a participant 12 and/or a plan sponsor 12 can indicate benefit plan information to be included in a summary of benefit plan information 800.

Various features of the invention are set forth in the following claims.

1. A method of providing benefit plan administration to a first sponsor having at least one participant enrolled in a benefit plan, the method comprising:
electronically receiving benefit plan information from the first sponsor;
electronically providing benefit plan information to the first sponsor; and
electronically providing benefit plan information to the at least one participant.

2. The method of claim 1 wherein electronically providing benefit plan information to the at least one participant includes providing benefit plan information about a plurality of benefit plans.

3. The method of claim 1 wherein electronically providing benefit plan information to the at least one participant includes providing retirement plan information.

4. The method of claim 3 wherein providing retirement plan information includes providing information about at least one of a qualified defined benefit retirement plan, a qualified defined contribution retirement plan, a nonqualified retirement plan, a stock ownership plan, a profit sharing retirement plan, a pension plan, a salary reduction retirement plan, and an individual retirement account plan.

5. The method of claim 1 wherein electronically providing benefit plan information to the at least one participant includes providing medical plan information.

6. The method of claim 5 wherein providing medical plan information includes providing information about a health savings account plan.

7. The method of claim 5 wherein providing medical plan information includes providing information about at least one of a health insurance plan, a lift insurance plan, a dental insurance plan, a pharmaceutical plan, a vision plan, a long term healthcare plan, a disability plan, a Social Security plan, a Medicare plan, and a Medicaid plan.

8. The method of claim 1 wherein electronically providing benefit plan information to the at least one participant includes providing non-medical plan information.

9. The method of claim 8 wherein providing non-medical plan information includes providing information about at least one of a worker's compensation plan, a Social Security plan, a bonus plan, a vacation compensation plan, a holiday compensation plan, a flexible spending account plan, a transportation compensation plan, a childcare plan, a tenure plan, a child support plan, an alimony plan, an automobile insurance plan, a homeowner's insurance plan, and a renters insurance plan.

10. The method of claim 1 wherein electronically providing benefit plan information to the at least one participant includes providing savings plan information.

11. The method of claim 10 wherein providing savings plan information includes providing information about at least one of a salary reduction plan, a college savings plan, a mutual fund investment plan, an individual retirement account plan, a loan, a mortgage, a savings account, a checking account, a stock, a mutual fund, a trust plan, a future contract plan, an option plan, a certificate of deposit, a bond, a credit card account, an annuity, and a money market account.

12. The method of claim 1 wherein electronically providing benefit plan information to the at least one participant includes providing a summary of benefit plan information.

13. The method of claim 12 wherein providing a summary of benefit plan information includes providing an indication of current and projected benefit plan information.

14. The method of claim 13 wherein providing an indication of current and projected benefit plan information includes providing a graphical indication of current and projected benefit plan information.

15. The method of claim 13 wherein providing an indication of current and projected benefit plan information includes providing a textual indication of current and projected benefit plan information.

16. The method of claim 12 wherein providing a summary of benefit plan information includes electronically providing the summary of benefit plan information to a client computer.

17. The method of claim 12 wherein providing a summary of benefit plan information includes providing the summary of benefit plan information on a printed statement.

18. The method of claim 12 further comprising updating the summary of benefit plan information.

19. The method of claim 18 wherein updating the summary of benefit plan information includes updating the summary of benefit plan information on a daily basis.

20. The method of claim 1 further comprising electronically receiving benefit plan information from a second sponsor.

21. The method of claim 1 further comprising electronically receiving benefit plan information from the at least one participant over a computer network.

22. The method of claim 1 further comprising electronically receiving benefit plan information from at least one of the first sponsor, a second sponsor, and the at least one participant and updating benefit plan information stored in at least one database based on the received benefit plan information.

23. The method of claim 22 wherein updating benefit plan information stored in at least one database includes updating benefit plan information about a first benefit plan and benefit plan information about a second benefit plan.

24. The method of claim 1 further comprising validating benefit plan information received from at least one of the first sponsor, a second sponsor, and the at least one participant.

25. The method of claim 1 further comprising receiving beneficiary information from at least one of the first sponsor and the at least one participant.

26. A system for providing benefit plan administration to a first sponsor having at least one participant enrolled in a benefit plan, the system comprising:
a server that receives benefit plan information from the first sponsor, provides secure access to benefit plan information to the first sponsor, and provides secure access to benefit plan information to the at least one participant.

27. The system of claim 26 wherein the benefit plan information includes information about a plurality of benefit plans.

28. The system of claim 26 wherein the benefit plan information includes retirement plan information.

29. The system of claim 28 wherein the retirement plan information includes information about at least one of a qualified defined benefit retirement plan, a qualified defined contribution retirement plan, a nonqualified retirement plan, a stock ownership plan, a profit sharing retirement plan, a pension plan, a salary reduction retirement plan, and an individual retirement account plan.

30. The system of claim 26 wherein the benefit plan information includes medical plan information.

31. The system of claim 30 wherein the medical plan information includes information about a health savings account plan.

32. The system of claim 30 wherein the medical plan information includes information about at least one of a health insurance plan, a lift insurance plan, a dental insurance plan, a pharmaceutical plan, a vision plan, a long term healthcare plan, a disability plan, a Social Security plan, a Medicare plan, and a Medicaid plan.

33. The system of claim 26 wherein the benefit plan information includes non-medical plan information.

34. The system of claim 33 wherein the non-medical plan information includes information about at least one of a worker's compensation plan, a Social Security plan, a bonus plan, a vacation compensation plan, a holiday compensation plan, a flexible spending account plan, a transportation compensation plan, a childcare plan, a tenure plan, a child support plan, an alimony plan, an automobile insurance plan, a homeowner's insurance plan, and a renters insurance plan.

35. The system of claim 26 wherein the benefit plan information includes savings plan information.

36. The system of claim 35 wherein the savings plan information includes information about at least one of a salary reduction plan, a college savings plan, a mutual fund investment plan, an individual retirement account plan, a loan, a mortgage, a savings account, a checking account, a stock, a mutual fund, a trust plan, a future contract plan, an option plan, a certificate of deposit, a bond, a credit card account, an annuity, and a money market account.

37. The system of claim 26 further comprising a computer.

38. The system of claim 37 wherein the server requests benefit plan information from the computer.

39. The system of claim 37 wherein the server sends benefit plan information from the first sponsor to the computer.

40. The system of claim 37 wherein the computer generates a summary of benefit plan information.

41. The system of claim 40 wherein the summary of benefit plan information includes an indication of current and projected benefit plan information.

42. The system of claim 41 wherein the indication of current and projected benefit plan information includes a graphical indication of current and projected benefit plan information.

43. The system of claim 41 wherein the indication of current and projected benefit plan information includes a textual indication of current and projected benefit plan information.

44. The system of claim 40 wherein server provides secure access to the summary of benefit plan information to the at least one participant.

45. The system of claim 40 wherein the computer updates the summary of benefit plan information.

46. The system of claim 45 wherein the computer updates the summary of benefit plan information on a daily basis.

47. The system of claim 37 wherein the server receives benefit plan information from a second sponsor.

48. The system of claim 47 wherein the server sends benefit plan information from the second sponsor to the computer.

49. The system of claim 37 wherein the server receives benefit plan information from the at least one participant.

50. The system of claim 49 wherein the server sends benefit plan information from the at least one participant to the computer.

51. The system of claim 37 wherein the computer updates benefit plan information stored in a benefit plan database based on benefit plan information received from at least one of the first sponsor, a second sponsor, and the at least one participant.

52. The system of claim 37 wherein the computer updates benefit plan information about a first benefit plan and benefit plan information about a second benefit plan.

53. The system of claim 37 wherein the computer validates benefit plan information received from at least one of the first sponsor, a second sponsor, and the at least one participant.

54. The system of claim 37 wherein the server receives beneficiary information from at least one of the first sponsor and the at least one participant.

55. The system of claim 54 wherein the server sends the beneficiary information to the computer.

56. A method of providing benefit plan administration to a sponsor having a plurality of participants enrolled in a benefit plan, the method comprising:
receiving benefit plan information from the sponsor;
determining eligibility information based on the benefit plan information; and
providing the sponsor access to the eligibility information.

57. The method of claim 56 wherein determining eligibility information includes determining at least one participant of the plurality of participants that is eligible for at least one benefit plan.

58. The method of claim 56 wherein receiving benefit plan information from the sponsor includes receiving participant information from the sponsor.

59. The method of claim 56 wherein providing the sponsor access to the eligibility information includes generating a report including information about at least one of the plurality of participants that is eligible for at least one benefit plan.

60. The method of claim 59 further comprising displaying the report on a client computer.

61. The method of claim 59 further comprising printing the report.

62. The method of claim 56 wherein providing the sponsor access to the eligibility information includes allowing the sponsor to sort the eligibility information.

63. The method of claim 56 wherein providing the sponsor access to the eligibility information includes allowing the sponsor to search the eligibility information.

64. The method of claim 62 wherein allowing the sponsor to sort the eligibility information includes allowing the sponsor to sort the eligibility information based on at least one of name, identification, date of birth, date of hire, and plan entry date.

65. The method of claim 56 wherein receiving benefit plan information includes comprising receiving eligibility requirements from the sponsor, the eligibility requirements including eligibility requirements for at least one benefit plan.

66. The method of claim 56 wherein receiving benefit plan information from the sponsor includes receiving retirement plan information.

67. The method of claim 66 wherein receiving retirement plan information includes receiving information about at least one of a qualified defined benefit retirement plan, a qualified defined contribution retirement plan, a nonqualified retirement plan, a stock ownership plan, a profit sharing retirement plan, a pension plan, a salary reduction retirement plan, and an individual retirement account plan.

68. The method of claim 56 wherein receiving benefit plan information includes receiving medical plan information.

69. The method of claim 68 wherein receiving medical plan information includes receiving information about a health savings account plan.

70. The method of claim 68 wherein receiving medical plan information includes receiving information about at least one of a health insurance plan, a lift insurance plan, a dental insurance plan, a pharmaceutical plan, a vision plan, a long term healthcare plan, a disability plan, a Social Security plan, a Medicare plan, and a Medicaid plan.

71. The method of claim 56 wherein receiving benefit plan information includes receiving non-medical plan information.

72. The method of claim 71 wherein receiving non-medical plan information includes receiving information about at least one of a worker's compensation plan, a Social Security plan, a bonus plan, a vacation compensation plan, a holiday compensation plan, a flexible spending account plan, a transportation compensation plan, a childcare plan, a tenure plan, a child support plan, an alimony plan, an automobile insurance plan, a homeowner's insurance plan, and a renters insurance plan.

73. The method of claim 56 wherein receiving benefit plan information includes receiving savings plan information.

74. The method of claim 73 wherein receiving savings plan information includes receiving information about at least one of a salary reduction plan, a college savings plan, a mutual fund investment plan, an individual retirement account plan, a loan, a mortgage, a savings account, a checking account, a stock, a mutual fund, a trust plan, a future contract plan, an option plan, a certificate of deposit, a bond, a credit card account, an annuity, and a money market account.

75. A method of providing benefit plan administration to a sponsor having at least one participant enrolled in a benefit plan, the method comprising:
electronically receiving participant information from the sponsor, wherein electronically receiving participant information from the sponsor includes at least one of manually entering the participant information and importing a file including the participant information.

76. The method of claim 75 wherein electronically receiving participant information from the sponsor includes receiving a selection of at least one benefit plan to be offered to the at least one participant.

77. The method of claim 75 wherein electronically receiving participant information from the sponsor includes receiving an indication of at least one benefit plan that the at least one participant will participant in.

78. The method of claim 75 further compromising electronically receiving an indication of a format of a file including participant information to import.

79. The method of claim 75 wherein electronically receiving participant information from the sponsor includes receiving an indication of a primary language of the at least one participant.

80. The method of claim 75 wherein electronically receiving participant information from the sponsor includes receiving an indication of at least one benefit plan that the at least one participant should be excluded from.

81. The method of claim 75 further comprising electronically displaying a list of entered participants for the sponsor to validate.

82. The method of claim 81 further comprising allowing the sponsor to sort the list of entered participants.

83. The method of claim 81 further comprising allowing the sponsor to search the list of entered participants.

84. The method of claim 75 further comprising allowing the sponsor to delete a portion of the participant information.

85. The method of claim 75 further comprising allowing the sponsor to edit a portion of the participant information.

86. The method of claim 75 further comprising allowing the sponsor to save the participant information.

87. The method of claim 75 further comprising submitting the participant information.

88. The method of claim 75 further comprising validating the participant information.

89. The method of claim 75 further comprising electronically providing the participant information to the sponsor.

90. The method of claim 75 wherein electronically receiving participant information from the sponsor includes receiving an indication of the at least one participant being rehired.

91. The method of claim 75 further comprising electronically receiving enrollment kit orders from the sponsor, generating at least one enrollment kit, and providing the at least one enrollment kit to at least one of the sponsor and the at least one participant.

92. The method of claim 75 further comprising receiving benefit plan information from the sponsor, electronically providing benefit plan information to the sponsor, and electronically providing benefit plan information to the at least one participant.

93. The method of claim 75 wherein electronically providing benefit plan information to the at least one participant includes providing retirement plan information.

94. The method of claim 93 wherein providing retirement plan information includes providing information about at least one of a qualified defined benefit retirement plan, a qualified defined contribution retirement plan, a nonqualified retirement plan, a stock ownership plan, a profit sharing retirement plan, a pension plan, a salary reduction retirement plan, and an individual retirement account plan.

95. The method of claim 75 wherein providing benefit plan information to the at least one participant includes providing medical plan information.

96. The method of claim 95 wherein providing medical plan information includes providing information about a health savings account plan.

97. The method of claim 95 wherein providing medical plan information includes providing information about at least one of a health insurance plan, a lift insurance plan, a dental insurance plan, a pharmaceutical plan, a vision plan, a long term healthcare plan, a disability plan, a Social Security plan, a Medicare plan, and a Medicaid plan.

98. The method of claim 75 wherein providing benefit plan information to the at least one participant includes providing non-medical plan information.

99. The method of claim 98 wherein providing non-medical plan information includes providing information about at least one of a worker's compensation plan, a Social Security plan, a bonus plan, a vacation compensation plan, a holiday compensation plan, a flexible spending account plan, a transportation compensation plan, a childcare plan, a tenure plan, a child support plan, an alimony plan, an automobile insurance plan, a homeowner's insurance plan, and a renters insurance plan.

100. The method of claim 75 wherein providing benefit plan information to the at least one participant includes providing savings plan information.

101. The method of claim 100 wherein providing savings plan information includes providing information about at least one of a salary reduction plan, a college savings plan, a mutual fund investment plan, an individual retirement account plan, a loan, a mortgage, a savings account, a checking account, a stock, a mutual fund, a trust plan, a future contract plan, an option plan, a certificate of deposit, a bond, a credit card account, an annuity, and a money market account.
